(19) United States
(12) Patent Application Publication
(10) Pub. No.: US 2022/0413272 A1
(43) Pub. Date: Dec. 29, 2022

(54) DELAY MIRROR AND DELAY MIRROR SYSTEM

(71) Applicant: TOKAI OPTICAL CO., LTD., Okazaki-Shi (JP)

(72) Inventor: Muneo SUGIURA, Okazaki-Shi (JP)

(73) Assignee: TOKAI OPTICAL CO., LTD., Okazaki-Shi (JP)

(21) Appl. No.: 17/929,821

(22) Filed: Sep. 6, 2022

Related U.S. Application Data
(63) Continuation of application No. PCT/JP2021/007754, filed on Mar. 1, 2021.

(30) Foreign Application Priority Data
Mar. 10, 2020 (JP) 2020-041185

(51) Int. Cl. G02B 17/00; G02B 5/08

(52) U.S. Cl. CPC G02B 17/004; G02B 5/0816

(57) ABSTRACT

A delay mirror 1 includes a base 2, and an optical multilayer film 4 formed on a surface R of the base 2. The value of a group delay in a first wavelength band according to the optical multilayer film 4 is different from the value of the group delay in the second wavelength band according to the optical multilayer film 4, and the value of a group delay dispersion in the first wavelength band according to the optical multilayer film 4 and the value of the group delay dispersion in the second wavelength band according to the optical multilayer film 4 are each not less than −100 fs² and not greater than 100 fs². Further, the delay mirror system includes a delay mirror movement mechanism which moves the delay mirror 1 such that the number of times of reflection is changed.

### CROSS REFERENCE TO RELATED APPLICATION

This application is a Continuation of International Application No. PCT/JP2021/007754, filed on Mar. 1, 2021, which claims the benefit of Japanese Patent Application Number 2020-041185 filed on Mar. 10, 2020, the disclosures of which are incorporated by reference herein in their entireties.

### FIELD OF THE INVENTION

The present invention relates to a delay mirror usable in a delay optical system, and a delay mirror system having the same.

### BACKGROUND OF THE INVENTION

Recently, a delay optical system having a level of femtoseconds (10⁻¹⁵ seconds) has been used. The delay optical system is an optical system for delaying a certain optical pulse with respect to another optical pulse.

For example, in Non-Patent Literature “Yuto Toida, ‘Observation of N₂ molecule Rydberg wave packet by extreme ultraviolet ultrafast photoelectron spectroscopy’, thesis for master's degree, graduate school, Nagoya University, March, 2014”, in order to observe an N₂ molecule Rydberg wave packet, an optical pulse emitted from a Ti: Sapphire laser is divided into light serving as the source of pump light having a wavelength 80 nm band (nanometer band) and probe light having a wavelength 800 nm band, and the probe light is applied to a sample in a state of being delayed at a femtosecond level with respect to the pump light. Slightly changing the delay time is repeated, whereby a fast phenomenon is visualized (pump-probe spectroscopy). This delay is performed by adjusting the optical path length of the probe light with use of four mirrors each inclined by 45° with respect to incident light. That is, these mirrors cause a part of the optical path of the probe light to have a “Π” shape, the second and third mirrors are mounted on a delay stage being a common stage, and the delay stage is moved with respect to the first and fourth mirrors, whereby the length of the optical path is changed, the optical path length of the probe light is adjusted, and the probe light is delayed by a desired time with respect to the pump light.

In Non-Patent Literature “N. Ishii et al., “Sub-two-cycle, carrier-envelope phase-stable, intense optical pulses at 1.6 μm from a BiB₃O₆ optical parametric chirped-pulse amplifier”, OPTICS LETTERS, Vol. 37, No. 20, Oct. 15, 2012, p. 4182-4184”, in order to cause seed light having a wavelength 1600 nm band and pump light having a wavelength 800 nm band to be simultaneously incident on BiB₃O₆ crystals, time adjustment is performed on the seed light with respect to the pump light, in a delay optical system using four mirrors as described above.

Further, a delay optical system using a pentagon prism structure described in JP 2008-102352 A below is known.

### SUMMARY OF THE INVENTION

In the delay optical system using four mirrors described above, the optical path of light having a wavelength to be delayed and the optical path of light having a wavelength different therefrom need to be separated. Thus, the delay optical system becomes complicated. In addition, in such a delay optical system, fine movement control of the delay stage is required in addition to accurate arrangement of a plurality of mirrors, and thus, installation and fine adjustment are difficult.

In the delay optical system using a pentagon prism structure described above as well, delay is caused by extending the optical path length with use of the pentagon prism structure after all. Therefore, similar to the delay optical system using four mirrors, division is required, and installation and fine adjustment of the pentagon prism structure and the like are difficult.

In addition, in a case of a femtosecond pulse, it is necessary to pay attention to the fact that, when the femtosecond pulse passes through the inside of glass, the pulse width changes due to influence of the refractive index dispersion thereof.

Therefore, a major object of the present invention is to provide a delay mirror that realizes a delay optical system in which delay can be made in a coaxial manner without separating the optical path of light to be delayed from the optical path of light having a wavelength different from that of the light to be delayed.

In addition, another major object of the present invention is to provide a delay mirror that is simple and that realizes a delay optical system of which installation and fine adjustment are easy.

Further, another major object of the present invention is to provide a delay mirror system that has the delay mirror described above and that realizes a delay optical system in which delay time can be adjusted in a simple manner.

In order to achieve the above object, the invention according to claim 1 is a delay mirror including: a base; and an optical multilayer film formed on a surface of the base. A value of a group delay (hereinafter referred to as GD) in a first wavelength band according to the optical multilayer film is different from a value of the GD in a second wavelength band according to the optical multilayer film.

In the invention according to claim 2 based on the above invention, a value of a group delay dispersion (hereinafter referred to as GDD) in the first wavelength band according to the optical multilayer film and a value of the GDD in the second wavelength band according to the optical multilayer film are each not less than −100 fs² and not greater than 100 fs².

In the invention according to claim 3 based on the above invention, a value of a GDD in the first wavelength band according to the optical multilayer film and a value of the GDD in the second wavelength band according to the optical multilayer film are each a negative value.

In the invention according to claim 4 based on the above invention, the value of the GDD in the first wavelength band is a value that realizes dispersion compensation of a first optical pulse according to the first wavelength band through a predetermined number of times of reflection, and the value of the GDD in the second wavelength band is a value that realizes dispersion compensation of a second optical pulse according to the second wavelength band through a predetermined number of times of reflection.

In the invention according to claim 5 based on the above invention, the first optical pulse and the second optical pulse are those having passed through a nonlinear optical crystal.

In the invention according to claim 6 based on the above invention, a value of a GDD in the first wavelength band according to the optical multilayer film and a value of a GDD in the second wavelength band according to the optical multilayer film are each a positive value.

In the invention according to claim 7 based on the above invention, out of a value of a GDD in the first wavelength band according to the optical multilayer film and a value of a GDD in the second wavelength band according to the optical multilayer film, one is a positive value and another is a negative value.

In the invention according to claim 8 based on the above invention, out of the first wavelength band and the second wavelength band, one is a 400 nm band and another is an 800 nm band.

In the invention according to claim 9 based on the above invention, out of the first wavelength band and the second wavelength band, one is a 515 nm band and another is a 1030 nm band.

In order to achieve the above object, an invention according to claim 10 is a delay mirror system including: the above delay mirror; and a delay mirror movement mechanism configured to move the delay mirror with respect to another mirror such that a number of times of reflection at the delay mirror is changed.

The invention according to claim 11 includes a pair of the delay mirrors.

A major effect of the present invention is that a delay mirror that realizes a delay optical system in which delay can be made in a coaxial manner without separating the optical path of light to be delayed from the optical path of light having a wavelength different from that of the light to be delayed, is provided.

In addition, another major effect of the present invention is that a delay mirror that is simple and that realizes a delay optical system of which installation and fine adjustment are easy, is provided.

Further, another major effect of the present invention is that a delay mirror system that has the delay mirror described above and that realizes a delay optical system in which delay time can be adjusted in a simple manner, is provided.

### BRIEF DESCRIPTION OF THE DRAWINGS

FIG. 1 is a schematic diagram of a delay mirror according to the present invention.

FIG. 2 is a schematic diagram of a delay mirror system according to the present invention.

FIG. 3 is a graph showing the physical film thickness of each layer according to Example 1-1 of the present invention.

FIG. 4 is a graph showing the physical film thickness of each layer according to Example 1-2 of the present invention.

FIG. 5 is a graph showing the spectral reflectance distribution (vertical axis: reflectance [%]) in a wavelength region (horizontal axis: wavelength [nm]) of 300 nm to 900 nm, according to Examples 1-1, 1-2.

FIG. 6 is a graph showing the GD (vertical axis, [fs]) in the same wavelength region, according to Examples 1-1, 1-2.

FIG. 7 is a graph showing the GDD (vertical axis, [fs²]) in the same wavelength region, according to Examples 1-1, 1-2.

FIG. 8 is a diagram similar to FIG. 4, according to Example 2-1.

FIG. 9 is a diagram similar to FIG. 4, according to Example 2-2.

FIG. 10 is a diagram similar to FIG. 5, according to Examples 2-1, 2-2.

FIG. 11 is a diagram similar to FIG. 6, according to Examples 2-1, 2-2.

FIG. 12 is a diagram similar to FIG. 7, according to Examples 2-1, 2-2.

FIG. 13 is a diagram similar to FIG. 4, according to Example 3.

FIG. 14 is a diagram similar to FIG. 5, according to Example 3.

FIG. 15 is a diagram similar to FIG. 6, according to Example 3.

FIG. 16 is a diagram similar to FIG. 7, according to Example 3.

FIG. 17 is a diagram similar to FIG. 4, according to Example 4.

FIG. 18 is a diagram similar to FIG. 5, according to Example 4.

FIG. 19 is a diagram similar to FIG. 6, according to Example 4.

FIG. 20 is a diagram similar to FIG. 7, according to Example 4.

FIG. 21 is a diagram similar to FIG. 4, according to Example 5.

FIG. 22 is a diagram similar to FIG. 5, according to Example 5.

FIG. 23 is a diagram similar to FIG. 6, according to Example 5.

FIG. 24 is a diagram similar to FIG. 7, according to Example 5.

FIG. 25 is a diagram similar to FIG. 4, according to Example 6.

FIG. 26 is a diagram similar to FIG. 5, according to Example 6.

FIG. 27 is a diagram similar to FIG. 6, according to Example 6.

FIG. 28 is a diagram similar to FIG. 7, according to Example 6.

FIG. 29 is a schematic diagram of a laser system having a pair of the delay mirrors (with dispersion compensation function) of Example 7.

FIG. 30 is a diagram similar to FIG. 4, according to Example 7.

FIG. 31 is a diagram similar to FIG. 5, according to Example 7.

FIG. 32 is a diagram similar to FIG. 6, according to Example 7.

FIG. 33 is a diagram similar to FIG. 7, according to Example 7.

FIG. 34 is a diagram similar to FIG. 4, according to Example 8.

FIG. 35 is a diagram similar to FIG. 5, according to Example 8.

FIG. 36 is a diagram similar to FIG. 6, according to Example 8.

FIG. 37 is a diagram similar to FIG. 7, according to Example 8.

FIG. 38 is a diagram similar to FIG. 4, according to Example 9.

FIG. 39 is a diagram similar to FIG. 5, according to Example 9.

FIG. 40 is a diagram similar to FIG. 6, according to Example 9.

FIG. 41 is a diagram similar to FIG. 7, according to Example 9.

FIG. 42 is a diagram similar to FIG. 4, according to Example 10.

FIG. 43 is a diagram similar to FIG. 5, according to Example 10.

FIG. 44 is a diagram similar to FIG. 6, according to Example 10.

FIG. 45 is a diagram similar to FIG. 7, according to Example 10.

FIG. 46 is a diagram similar to FIG. 4, according to Example 11.

FIG. 47 is a diagram similar to FIG. 5, according to Example 11.

FIG. 48 is a diagram similar to FIG. 6, according to Example 11.

FIG. 49 is a diagram similar to FIG. 7, according to Example 11.

FIG. 50 is a diagram similar to FIG. 4, according to Example 12.

FIG. 51 is a diagram similar to FIG. 5, according to Example 12.

FIG. 52 is a diagram similar to FIG. 6, according to Example 12.

FIG. 53 is a diagram similar to FIG. 7, according to Example 12.

FIG. 54 is a diagram similar to FIG. 4, according to Example 13.

FIG. 55 is a diagram similar to FIG. 5, according to Example 13.

FIG. 56 is a diagram similar to FIG. 6, according to Example 13.

FIG. 57 is a diagram similar to FIG. 7, according to Example 13.

### DETAIL DESCRIPTION OF THE INVENTION

Hereinafter, examples of an embodiment according to the present invention will be described with reference to the drawings as appropriate. It is noted that the embodiment of the present invention is not limited to these examples.

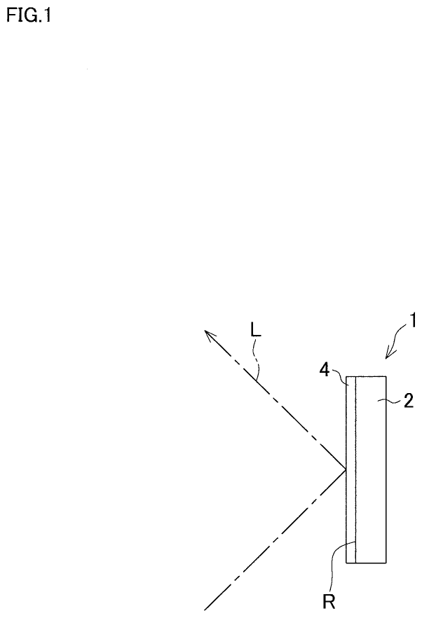

As shown in FIG. 1, a delay mirror 1 according to the present invention has a base 2 and an optical multilayer film 4.

The base 2 includes a surface R on which the optical multilayer film 4 is formed. The delay mirror 1 reflects a plurality of optical pulses having different wavelength bands from each other, at the optical multilayer film 4 coated on the surface R, thereby delaying, with respect to an optical pulse having a predetermined wavelength band, an optical pulse having another wavelength band. These optical pulses can pass along the same optical path L.

The base 2 may have translucency or may not have translucency.

The material of the base 2 is not limited in particular, and is glass, crystals, ceramics, or resin, for example.

The shape of the base 2 is not limited in particular, and is a parallel flat plate shape or a wedged shape, for example.

A GD of the optical multilayer film 4 has a value that is different for each wavelength band.

The GD is defined by a reflection phase ϕ of the optical multilayer film 4. After a wave cos(ωₙ t) having an angular frequency ωₙ and a wave cos{(ωₙ+Δω)t} having an angular frequency ωₙ+Δω are reflected at the optical multilayer film 4, the respective waves become ρ cos{ωₙt+ϕ(ωₙ)} and ρ cos{(ωₙ+Δω)t+ϕ(ωₙ+Δω)}, with ρ used as a Fresnel reflection coefficient of the optical multilayer film 4. Here, ρ is a constant, for simplification.

A wave obtained through superposition of these is represented by the following formulae (1a), (1b). That is, the wave obtained through superposition of these is a wave that has an amplitude Eₙ₀(t) having been subjected to time modulation. When many waves are superposed according to n=1, 2, 3, etc., modulation becomes sharp, and the superposed wave becomes a pulse train.

When Δω/ωₙ<<1, formula (1b) can be deformed into the following formula (2).

$${E}_{n} ( t ) = {E}_{n 0} ( t ) cos \{ ( {ω}_{𝔫} + \frac{Δ ω}{2} ) t + \frac{∅ ( {ω}_{n} ) + ∅ ( {ω}_{n} + Δ ω )}{2} \} \qquad ( 1 a )$$

$${E}_{n 0} ( t ) = 2 ρ cos \{ \frac{Δ ω}{2} t - \frac{∅ ( {ω}_{n} ) - ∅ ( {ω}_{n} + Δ ω )}{2} \} \qquad ( 1 b )$$

$${{E}_{n 0} ( t ) ≅ 2 ρ cos \{ \frac{Δ ω}{2} ( t + \frac{{\partial }_{t} ∅}{\partial ω} {\vert}_{{ω}_{n}} ) + \frac{1}{4} \frac{{\partial }^{2} ∅}{\partial {ω}^{2}} \vert}_{{ω}_{n}} {( Δ ω )}^{2} + … \} \qquad ( 2 )$$

From formula (2), due to reflection at the optical multilayer film 4, a time t becomes t+∂ϕ/∂ω|_{ωn}, and thus, there is an effect of providing time delay to a pulse or modulation. The wavelength of a standing wave that occurs in a laser resonator that emits an optical pulse has discrete values, and thus, ωₙ takes discrete values. However, since Δω is a minute amount, ωₙ is considered to be a continuous variable. Then, the GD is defined as follows.

GD=−∂ϕ/∂ω (3)

The GD is a value according to the stay time in the optical multilayer film 4. Therefore, when the GD is different for each wavelength band, an optical pulse, with respect to an optical pulse belonging to a certain wavelength band, that belongs to another wavelength band will be delayed by the difference of the stay time. The greater the GD is, the longer the stay time in the optical multilayer film 4, and in accordance with the difference in the GD, an optical pulse having a wavelength band for which the GD is greater is delayed with respect to an optical pulse having a wavelength band for which the GD is smaller. Thus, the delay mirror 1 is composed of the optical multilayer film 4 having a different GD for each wavelength band.

Alternatively, the difference in the GD may be grasped in terms of the wavelength belonging to each wavelength band. That is, when the GD in a first wavelength band and the GD in a second wavelength band are caused to be different from each other, a delay based on the difference in the stay time is provided.

It is noted that the GD may be further caused to be different in a third wavelength band, in addition to the first wavelength band and the second wavelength band described above, that has a wavelength different from these. Similarly, a fourth wavelength band or a wavelength band at a higher ordinal number may be further set so as to have a GD that is different from each other.

Meanwhile, in ∂²ϕ/∂ω²|_{ωn} being the lowest order term of non-linear terms of ω, ω=ωₙ is substituted as ϕ, and ∂²ϕ/∂ω²|_{ωn} corresponds to a GDD. When the group delay is shifted (when there is dispersion), wave packets having various wavelengths forming an optical pulse are respectively shifted, whereby the shape of the optical pulse is changed.

That is, the GDD is represented as follows.

GDD=−∂²ϕ/∂ω² (4)

When the shapes of a preceding optical pulse and an optical pulse to be delayed are not to be changed, the GDD is 0 or is close to 0 in the wavelength band of each optical pulse (provision of a low dispersion mirror function). As described later, in a case where the pulse width is not less than about 40 fs, if the GDD is within a range of not less than −100 fs² and not greater than 100 fs², deformation of the optical pulse is little when compared with that in other cases, and it can be considered that there is substantially no deformation of the optical pulse or influence thereof. With respect to a pulse that has a narrower pulse width, the value of the GDD needs to be smaller. It is noted that the lower limit of the range can be set to any of −80, −60, −40, −20, 0, 20, 40, 60, 80, or the like, and the upper limit of the range can be set to any of 80, 60, 40, 20, 0, −20, −40, −60, −80, or the like.

Alternatively, when optical pulse deformation is to be performed in order to perform dispersion compensation, etc., as well as delaying, the GDD is caused to have a value according to the deformation, in the wavelength band of each optical pulse (provision of another function by deformation).

The optical multilayer film 4 is an inorganic multilayer film using a dielectric material or a semiconductor material, and is a dielectric multilayer film or a semiconductor multilayer film.

The optical multilayer film 4 is formed on a part or the entirety of at least one surface of the base 2.

The optical multilayer film 4 includes a low-refractive index layer and a high-refractive index layer. In addition, the optical multilayer film 4 can further include a middle-refractive index layer.

The design of the optical multilayer film 4 is changed through change of design elements such as selection of the number and materials of layers of the high-refractive index layer and the low-refractive index layer (and the middle-refractive index layer), and increase/decrease of the thickness (physical film thickness or optical film thickness of the layer) of each layer.

For example, through replacement or the like of the middle-refractive index layer by a combination of a high-refractive index layer and a low-refractive index layer that are optically equivalent thereto, the structure of a part or the entirety of the optical multilayer film 4 may be replaced by another structure that is optically equivalent.

The high-refractive index layer is formed from a high-refractive index material such as, for example, zirconium oxide (ZrO₂), titanium oxide (TiO₂), tantalum oxide (Ta₂O₅), niobium oxide (Nb₂O₅), hafnium oxide (HfO₂), lanthanum oxide (La₂O₃), silicon (Si), or praseodymium oxide (Pr₂O₃), or a mixture of two or more types of these.

Further, the low-refractive index layer is formed from a low-refractive index material such as, for example, silicon oxide (SiO₂), aluminum oxide (Al₂O₃), calcium fluoride (CaF₂), magnesium fluoride (MgF₂), a combination (Al₂O₃—Pr₂O₃) of aluminum oxide and praseodymium oxide, a combination (Al₂O₃—La₂O₃) of aluminum oxide and lanthanum oxide, or a combination (Al₂O₃—Ta₂O₅) of aluminum oxide and tantalum oxide, or a mixture of two or more types of these.

The middle-refractive index layer is formed from a middle-refractive index material such as, for example, Al₂O₃, Pr₂O₃, La₂O₃, Al₂O₃—Pr₂O₃, or Al₂O₃—La₂O₃.

It is noted that, for example, two materials are selected from the high-refractive index materials described above, whereby the optical multilayer film 4 may be formed. Further, a film having another function, such as an antifouling film, may be combined on the outside or in the inside of the optical multilayer film 4.

The low-refractive index layer and the high-refractive index layer (and the middle-refractive index layer) of the optical multilayer film 4 are formed by a vacuum deposition method, an ion assisted deposition method, an ion plating method, a sputtering method, or the like.

The optical multilayer film 4 may be formed on a plurality of surfaces of the base 2. For example, the optical multilayer film 4 may be formed on both of obverse and reverse surfaces of the base 2 having a parallel flat plate shape, a wedged shape, a concave shape, or a convex shape.

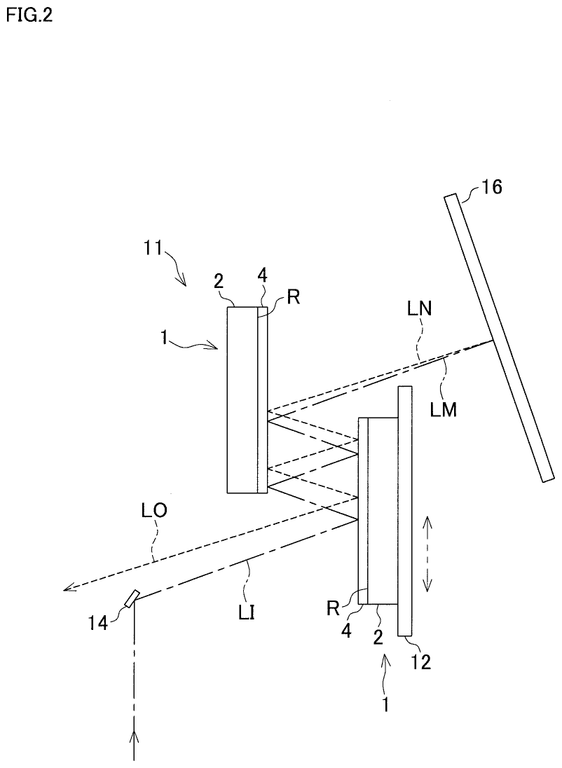

Further, as shown in FIG. 2, a delay mirror system 11 is formed so as to include one or more delay mirrors 1, and a movement mechanism 12 serving as a delay mirror movement mechanism which moves at least one delay mirror 1 with respect to another delay mirror 1.

The delay mirror system 11 has the following configuration so as to prevent movement of an outgoing optical path LO of an outgoing optical pulse. It is noted that up, down, left, and right in the delay mirror system 11 are the same as up, down, left, and right in FIG. 2 for convenience of description. However, in actuality, up, down, left, and right are not limited thereto.

That is, in the delay mirror system 11, two delay mirrors 1 are disposed in a state where the two delay mirrors 1 are parallel with each other and parts of the surfaces R face each other. These delay mirrors 1 are shifted from each other in the up-down direction, and the right delay mirror 1 is positioned below the left delay mirror 1.

The right delay mirror 1 has the movement mechanism 12 coupled thereto. The movement mechanism 12 has a stage on which the delay mirror is mounted, and a drive unit which moves the stage up and down. The right delay mirror 1 is moved, by the movement mechanism 12, in the up-down direction while the parallel state with respect to the left delay mirror 1 is maintained.

To the left below the left delay mirror 1, an incoming-side mirror 14 which leads an incoming optical pulse (incoming optical path LI) to the right delay mirror 1 is disposed.

To the right above the right delay mirror 1, an end mirror 16 which returns the optical pulse (intermediate incoming optical path LM) that has once advanced from the left delay mirror 1 rightward, to the left delay mirror 1, is disposed. The end mirror 16 is inclined such that, with respect to the intermediate incoming optical path LM, an intermediate outgoing optical path LN which is reflection thereof does not completely overlap the intermediate incoming optical path LM.

In the delay mirror system 11, in the state in FIG. 2, the left and right delay mirrors 1 cause a total of eight times of reflection, i.e., four times before reflection on the end mirror 16 and four times after reflection on the end mirror 16. Therefore, a delay eight-fold longer than a delay caused by a single time of reflection at the delay mirror 1 is obtained in the outgoing optical path LO. For example, when a delay of 40 fs (femtoseconds) is caused by a single time of reflection, a delay of 320 fs is obtained by eight times of reflection.

Further, when, from the state in FIG. 2, the right delay mirror 1 is raised by the movement mechanism 12 such that ten times of reflection is obtained instead of eight times before the raise, a delay (e.g., 400 fs) 10-fold longer than a delay caused by a single time of reflection is obtained.

On the other hand, when, from the state in FIG. 2, the right delay mirror 1 is lowered by the movement mechanism 12 such that six times of reflection is obtained instead of eight times before the lowering, a delay (e.g., 240 fs) 6-fold longer than a delay caused by a single time of reflection is obtained.

In a manner similar to these, when the number of times of reflection at the left and right delay mirrors 1 is changed in accordance with a movement amount of the right delay mirror 1, the delay time can be increased/decreased in a simple manner.

As conventionally performed, when optical paths are separated for each wavelength, and one optical path is made longer than the other optical path, the optical path needs to be increased by 119.9 μm in order to provide a time difference of 400 fs, for example.

In contrast to this, in the delay mirror system 11, in order to provide a time difference of 400 fs, it is sufficient that a total of ten times of reflection are caused at the delay mirrors 1, at each of which a delay of 40 fs is caused by a single time of reflection.

Further, conventionally, in order to adjust the magnitude of the time difference, the length of one optical path needs to be precisely controlled so as to correspond to a desired time difference, and if the length is wrong, an error of the time difference is directly caused.

In contrast to this, in the delay mirror system 11, control of the movement mechanism 12 only needs to be performed to an extent that change in the number of times of reflection can be ensured. Although the time difference is adjusted based on selection from among multiples of natural numbers of the time difference at a single time of reflection, and thus, becomes discrete to some extent, the magnitude of the time difference can be adjusted more easily and accurately.

It is noted that the delay mirror system 11 has modifications as follows.

That is, the delay mirror 1 may be provided while being combined with a low dispersion mirror or the like such that a plurality of times of reflection are caused by a single delay mirror 1. Alternatively, three or more delay mirrors 1 may be provided. The plurality of delay mirrors may be configured such that a delay time per reflection at some of the plurality of delay mirrors is different from the delay time of another delay mirror.

A plurality of delay mirrors 1 that can be moved by the movement mechanism 12 may be provided. Movement by the movement mechanism 12 may include rotational movement. At least one of the incoming-side mirror 14 and the end mirror 16 may be movable.

The end mirror 16 may be omitted, and the intermediate incoming optical path LM in FIG. 2 may serve as the outgoing optical path.

Next, Examples according to the above embodiment of the present invention are shown.

However, Examples do not limit the scope of the present invention. In particular, although the center wavelengths (first center wavelength and second center wavelength) of Examples are a 400 nm band and an 800 nm band, or a 515 nm band and a 1030 nm band, various center wavelengths in the present invention are not limited thereto. The center wavelength is a wavelength at a center in terms of design in a predetermined wavelength region (wavelength band). The 400 nm band is a region that includes 400 nm, and this applies in a similar manner to a band other than the 400 nm band. Such a region (wavelength band in the case of wavelength) is used in order to indicate that the wavelength of a wave packet included in an optical pulse has a width, that the center wavelength is not limited to a single value, and the like. For example, that the center wavelength is a 400 nm band means that the center wavelength is not limited to 400 nm and may be a wavelength around 400 nm.

In addition, depending on interpretation of the present invention, an Example may become a substantial Comparative Example that is outside the scope of the present invention, or a Comparative Example may become a substantial Example that is in the scope of the present invention.

As Examples of the present invention, formation of delay mirrors 1 that respectively have, on one surface (the surface R) of the base 2 having the same plate shape, optical multilayer films 4 that have different film configurations from each other was simulated.

The base 2 has a circular plate shape having a diameter of 30 mm (millimeters), and is made of optical glass BK7.

It is noted that, in each Example, the optical multilayer film 4 on the surface R is a dielectric multilayer film, and can be actually formed through vacuum deposition by causing film substances to be alternately vapor-deposited in a state where each film thickness is controlled.

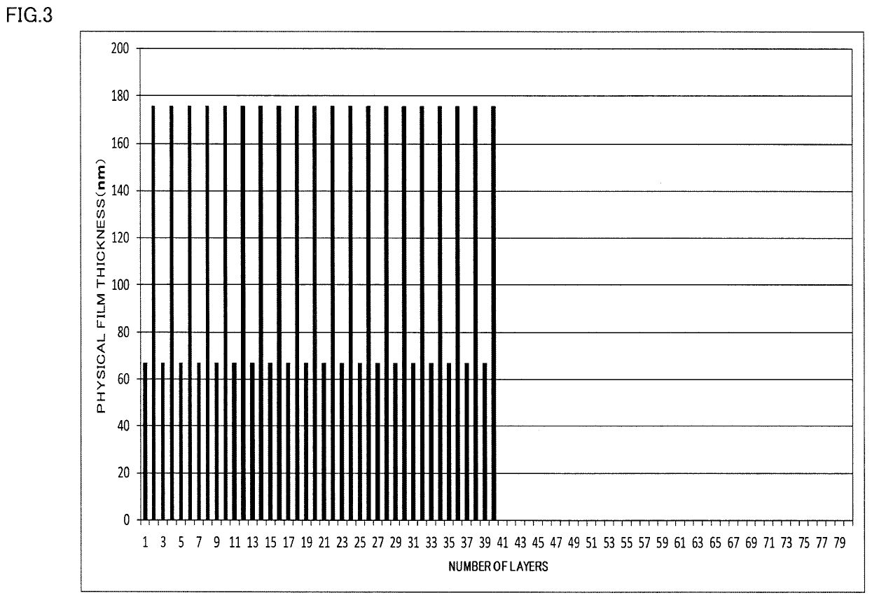

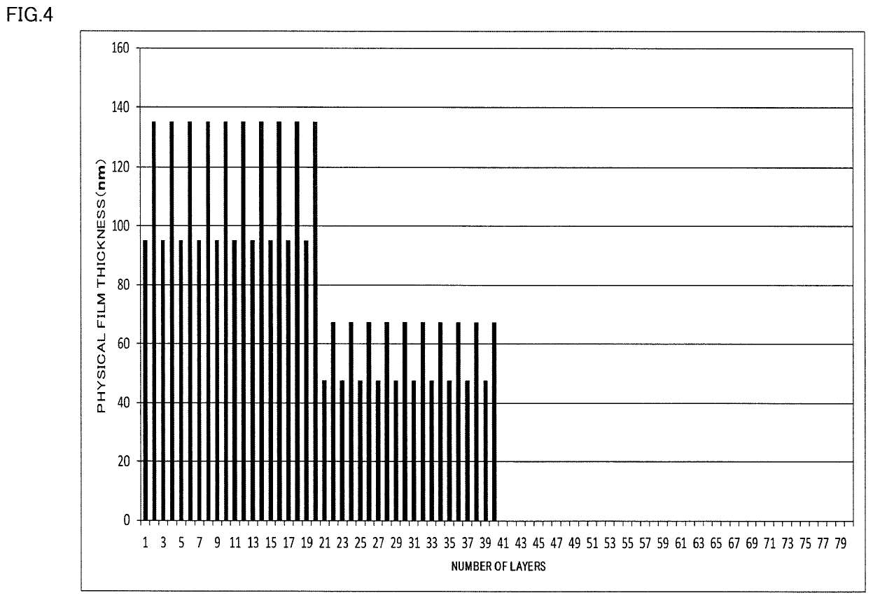

The optical multilayer film 4 of Examples 1-1, 1-2 is an alternate film in which, when the layer closest to the base 2 is defined as a first layer, odd number layers are Ta₂O₅ (high-refractive index layer by high-refractive index material) and even number layers are SiO₂ (low-refractive index layer by low-refractive index material). Each layer has a physical film thickness as shown in FIG. 3 (Example 1-1) or FIG. 4 (Example 1-2). The total number of layers of the optical multilayer film 4 in each of Examples 1-1, 1-2 is 40.

Examples 1-1, 1-2 are each designed such that the center wavelengths are 400 nm and 800 nm.

The configuration of the optical multilayer film 4 in Examples 1-1, 1-2 can be represented by signs described below. That is, p times of repetition of the configuration in ( ) is represented by ( )^{p}. A high-refractive index layer of which the optical film thickness at perpendicular incidence is λ₀/4 is represented by H. A low-refractive index layer of which the optical film thickness at perpendicular incidence is λ₀/4 is represented by L. When a coefficient (multiplier) of λ₀/4 is indicated immediately before H and L, the configuration of the optical multilayer film 4 in Example 1-1 is represented by base 2|(0.7H 1.3L)²⁰|air, and the configuration of the optical multilayer film 4 in Example 1-2 is represented by base 2|(1H 1L)¹⁰(0.5H 0.5L)¹⁰|air. It is noted that, in actuality, the optical multilayer film 4 may be subjected to fine adjustment such that, for example, with respect to the configuration represented by the signs, one or more predetermined optical film thicknesses are increased/decreased. That is, such signs may represent a basic design of the optical multilayer film 4.

The optical multilayer film 4 of Example 1-1 can be considered to be in imbalance such that, with respect to (1H 1L)²⁰, the optical film thickness of each high-refractive index layer is decreased (×0.7) and the optical film thickness of each low-refractive index layer is increased (×1.3).

The optical multilayer film 4 of Example 1-2 has a base-side lamination layer part (first lamination layer part) being (1H 1L)¹⁰, and an air-side lamination layer part (second lamination layer part) being (0.5H 0.5L)¹⁰. The first lamination layer part serves as a mirror for light in an 800 nm band, and the second lamination layer part serves as a mirror for light in a 400 nm band.

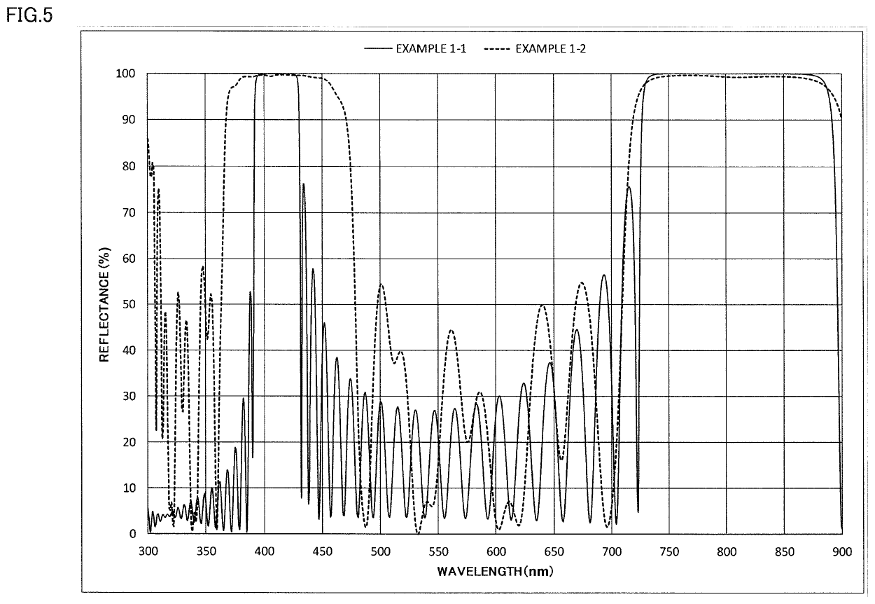

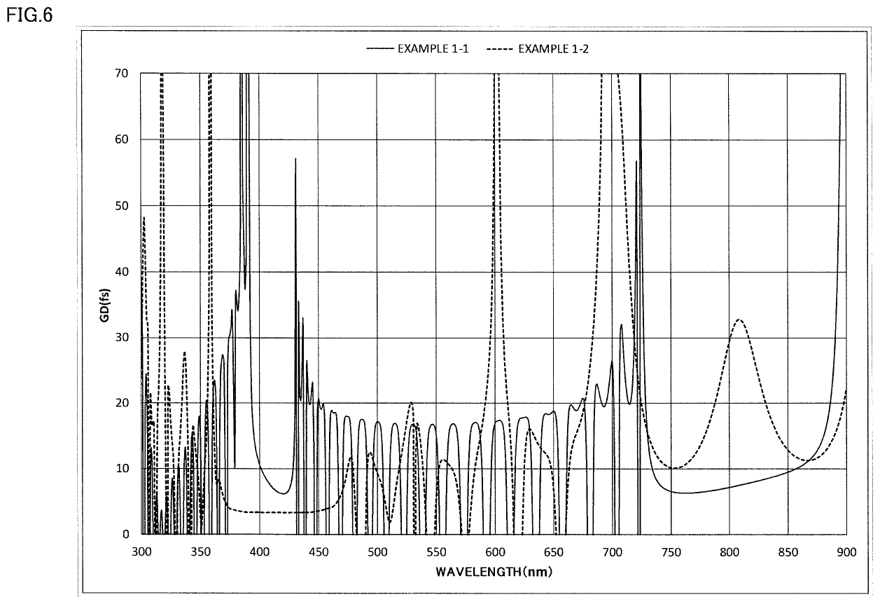

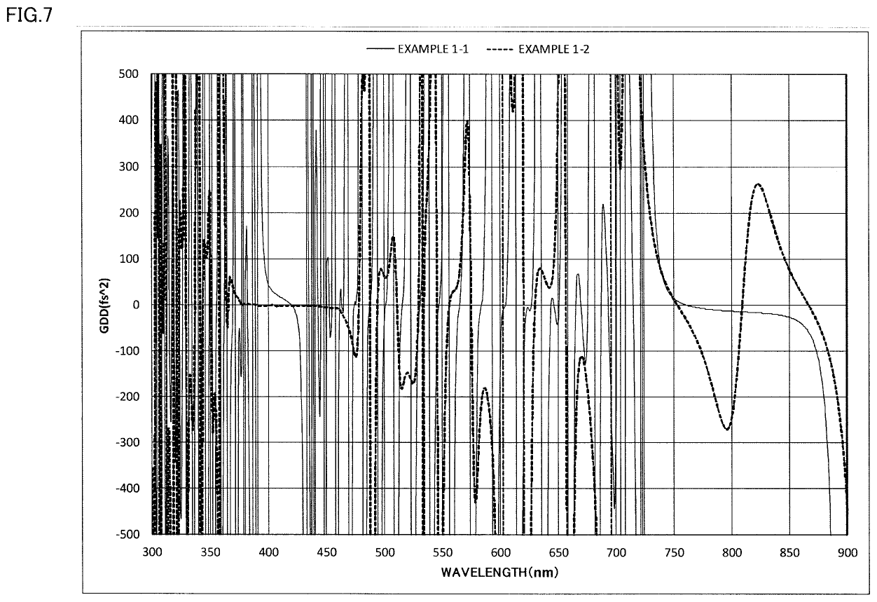

FIG. 5 is a graph showing the spectral reflectance distribution (vertical axis: reflectance [%]) in a wavelength region (horizontal axis: wavelength [nm]) of not less than 300 nm and not greater than 900 nm, according to Examples 1-1, 1-2. FIG. 6 is a graph showing the GD (vertical axis, [fs]) in the same wavelength region, according to Examples 1-1, 1-2. FIG. 7 is a graph showing the GDD (vertical axis, [fs²]) in the same wavelength region, according to Examples 1-1, 1-2. It is noted that FIG. 5 to FIG. 7 are those obtained at an incidence angle of 5°.

Example 1-1 exhibits high reflection in which the reflectance is about 100% in a wavelength region (400 nm band) of not less than 390 nm and not greater than 430 nm including a wavelength of 400 nm, and exhibits high reflection in a wavelength region (800 nm band) of not less than 730 nm and not greater than 890 nm including a wavelength of 800 nm.

Example 1-2 exhibits high reflection in a wavelength region (400 nm band) of not less than 375 nm and not greater than 450 nm, and in a wavelength region (800 nm band) of not less than 730 nm and not greater than 890 nm.

In Example 1-1, while the GD is 10 fs at the wavelength of 400 nm, the GD is 7 fs at the wavelength of 800 nm. The stay time in the optical multilayer film 4 of an 800 nm band optical pulse becomes longer than the stay time of a 400 nm band optical pulse, and the 800 nm band optical pulse is delayed with respect to the 400 nm band optical pulse. It is noted that if the group delays GD are the same value at the wavelengths of 400 nm and 800 nm, the stay times at the optical multilayer film 4 are the same between the 800 nm band optical pulse and the 400 nm band optical pulse, and there is no time difference between the 800 nm band optical pulse and the 400 nm band optical pulse even if there are reflections at the optical multilayer film 4. Therefore, this assumption example is a Comparative Example that does not belong to the present invention.

In Example 1-2, while the GD is 4 fs at the wavelength of 400 nm, the GD is 30 fs at the wavelength of 800 nm. The stay time in the optical multilayer film 4 of an 800 nm band optical pulse becomes longer than the stay time of a 400 nm band optical pulse, and the 800 nm band optical pulse is delayed with respect to the 400 nm band optical pulse. The magnitude of delay (the difference between the GD of the 800 nm band optical pulse and the GD of the 400 nm band optical pulse, i.e., 30−4=26 fs) in Example 1-2 is greater than that (3 fs) in Example 1-1.

In Example 1-1, the GDD is about 0 fs² at the wavelengths 400 nm and 800 nm, and the shapes of both of the 400 nm band optical pulse and the 800 nm band optical pulse are not changed. Since Example 1-1 has a high reflectance at the center wavelength thereof, a relatively small difference (3 fs) in the GD, and the aspect of the GDD being about 0 fs², it can be said that Example 1-1 corresponds to a delay mirror 1 that is similar to a two-wavelength standard mirror of which the center wavelengths are 400 nm and 800 nm.

In Example 1-2, although the GDD is about 0 fs² at the wavelength of 400 nm, the GDD is about −250 fs² and is not 0 fs² at the wavelength of 800 nm, and although the 400 nm band optical pulse is not deformed, the 800 nm band optical pulse is slightly deformed.

In Examples 1-1, 1-2, with respect to the 400 nm band optical pulse and the 800 nm band optical pulse, a time difference can be provided in a coaxial manner through reflection along the same optical path.

In the above description regarding Examples 1-1, 1-2, in order to clarify the relationship between the GD and the delay of a pulse, the group delays GD at the wavelengths 400 nm and 800 nm were used. Therefore, in the above description, although the wording of the 400 nm band optical pulse and the 800 nm band optical pulse are used, such pulses are those composed only of light at wavelengths that are very close to the wavelengths of 400 nm and 800 nm. With respect to delay, etc., of an optical pulse (having a broader wavelength band) composed of light in a broader wavelength region, it is necessary to focus on the GD and the GDD in the 400 nm band and the 800 nm band.

Through simulation of Examples 1-1, 1-2 and the like, or other examples, the following was found. That is, as long as the GDD is within a range of not less than −100 fs² and not greater than 100 fs², with respect to an optical pulse having a pulse width of not less than 40 fs, deformation is little when compared with that in other cases, and it can be considered that there is substantially no deformation of the optical pulse or influence thereof. When the pulse width is narrower, a GDD of which the absolute value is smaller is required. It is noted that the lower limit of the range can be any of −80, −60, −40, −20, 0, 20, 40, 60, 80, or the like, and the upper limit of the range can be any of 80, 60, 40, 20, 0, −20, −40, −60, −80, or the like.

Examples 2-1, 2-2 are obtained by expanding each wavelength band while maintaining each center wavelength in Example 1-2.

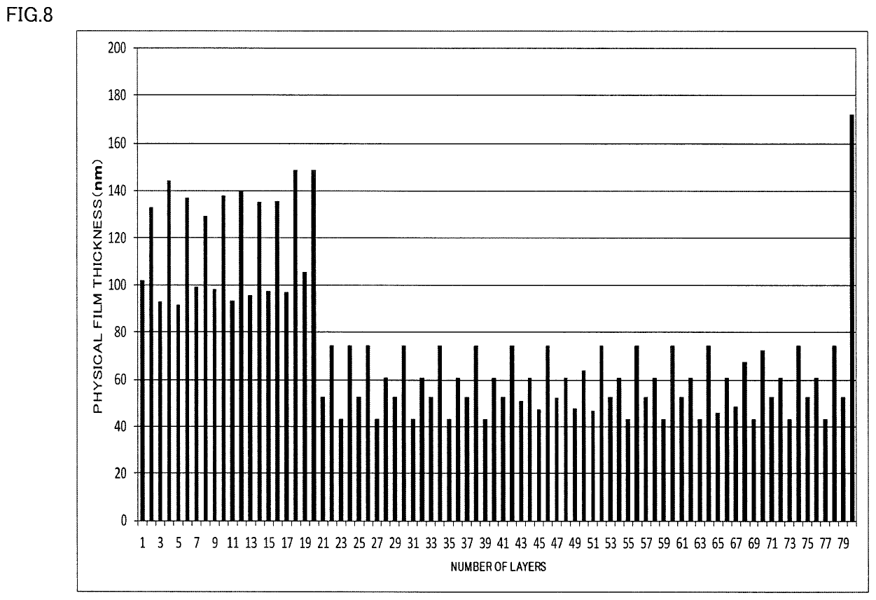

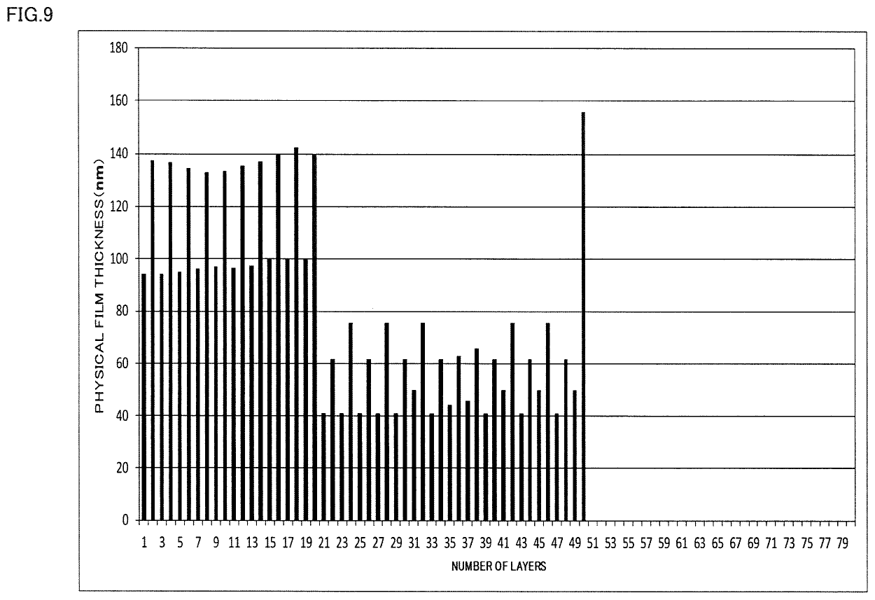

FIG. 8 is a diagram similar to FIG. 4, according to Example 2-1. FIG. 9 is a diagram similar to FIG. 4, according to Example 2-2.

The optical multilayer film 4 of each of Examples 2-1, 2-2 is an alternate film in which odd number layers are Ta₂O₅ and even number layers are SiO₂, as in other Examples.

Example 2-1 is formed such that: the number of layers in the second lamination layer part of Example 1-2 is increased; Example 2-1 has base 2|(1H 1L)¹⁰(0.5H 0.5L)³⁰0.7L|air as the basic design; and further, the physical film thickness of each layer is optimized. At the layer closest to the air side, 0.5+0.7=1.2L, and the total number of layers of the optical multilayer film 4 of Example 2-1 is 10×2+30×2=80.

Example 2-2 is formed so as to be the same as Example 2-1 except for the increased number of layers in the second lamination layer part, and such that: Example 2-2 has base 2|(1H 1L)¹⁰(0.5H 0.5L)¹⁵0.7L|air as the basic design; and further, the physical film thickness of each layer is optimized. The total number of layers of the optical multilayer film 4 of Example 2-2 is 50.

Examples 2-1, 2-2 can be considered to have, in the second lamination layer part, an excessive number of layers compared with that necessary for ensuring reflectance.

The optical film thickness of the second lamination layer part of Example 2-1 is 6187.8 nm. The one-way time when an optical pulse passes through the second lamination layer part is 6187.8 [nm]/299.79[nm/fs]=20.6[fs].

The optical film thickness of the second lamination layer part of Example 2-2 is 3001.1 nm. The one-way time when an optical pulse passes through the second lamination layer part is 3001.1 [nm]/299.79[nm/fs]=10.0[fs].

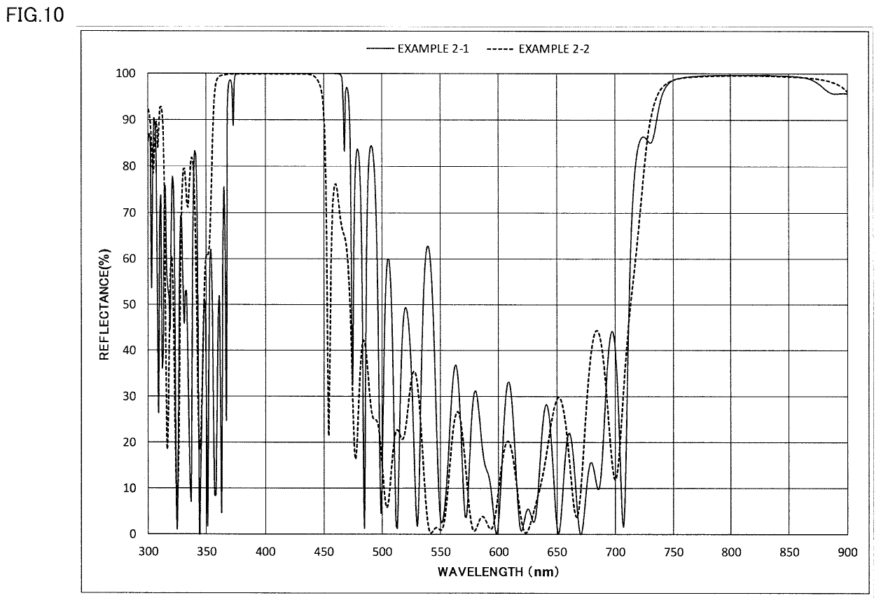

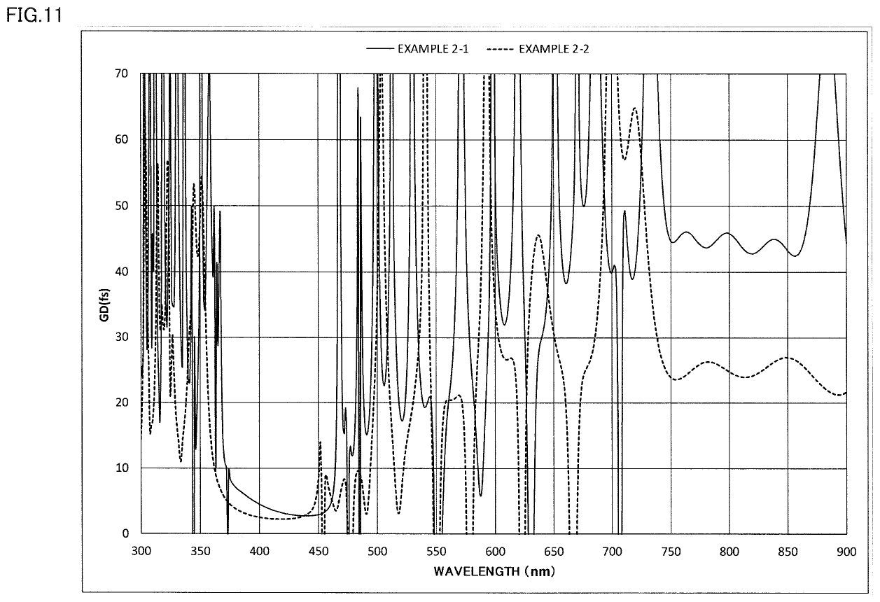

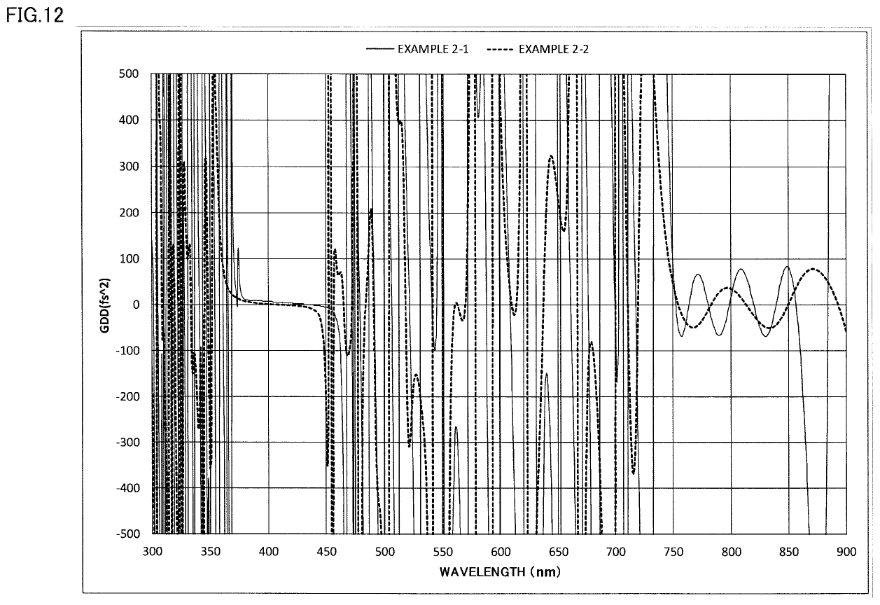

FIG. 10 to FIG. 12 are diagrams similar to FIG. 5 to FIG. 7, according to Examples 2-1, 2-2. FIG. 10 to FIG. 12 are those obtained at an incidence angle of 5°.

Example 2-1 exhibits high reflection in a wavelength region (400 nm band) of not less than 375 nm and not greater than 475 nm, and in a wavelength region (800 nm band) of not less than 750 nm and not greater than 860 nm.

Example 2-2 exhibits high reflection in a wavelength region (400 nm band) of not less than 360 nm and not greater than 440 nm, and in a wavelength region (800 nm band) of not less than 750 nm and not greater than 880 nm.

In Example 2-1, while the GD is about 5 fs in the 400 nm band, the GD is about 45 fs in the 800 nm band, and the difference of the latter relative to the former is about 40 fs. This 40 fs corresponds to about 2-fold of the one-way time regarding the second lamination layer part described above. This is because: a 400 nm band optical pulse round-trips, in the course of reflection, through a part of layers (the portion that functions as a reflection film for the 400 nm band optical pulse) on the air side of the second lamination layer part, whereas an 800 nm band optical pulse round-trips, in the course of reflection, through the entirety of the second lamination layer part and the first lamination layer part (a reflection film for the 800 nm band optical pulse).

In Example 2-2, while the GD is about 4 fs in the 400 nm band, the GD is about 24 fs in the 800 nm band, and the difference of the latter relative to the former is about 20 fs. This 20 fs corresponds to about 2-fold of the one-way time regarding the second lamination layer part described above.

In each of Examples 2-1, 2-2, the GDD are about 0 fs² in the wavelength 400 nm band and the wavelength 800 nm band, and the shapes of both of the 400 nm band optical pulse and the 800 nm band optical pulse are not changed. It is noted that the GDD only needs to be sufficiently smaller than a maximum value or a local maximum value in the wavelength region between the first center wavelength and the second center wavelength, and for example, only needs to be not greater than 1% or not greater than 0.1% of the maximum value or the local maximum value. This also applies hereafter.

Examples 2-1 and 2-2 respectively serve as low-dispersion delay mirrors 1 that delay, through a single time of reflection of each optical pulse and without deforming the optical pulse, an 800 nm band optical pulse with respect to a 400 nm band optical pulse by about 40 fs and about 20 fs. In Examples 2-1, 2-2, with respect to the 400 nm band optical pulse and the 800 nm band optical pulse, a time difference can be provided in a coaxial manner through reflection along the same optical path.

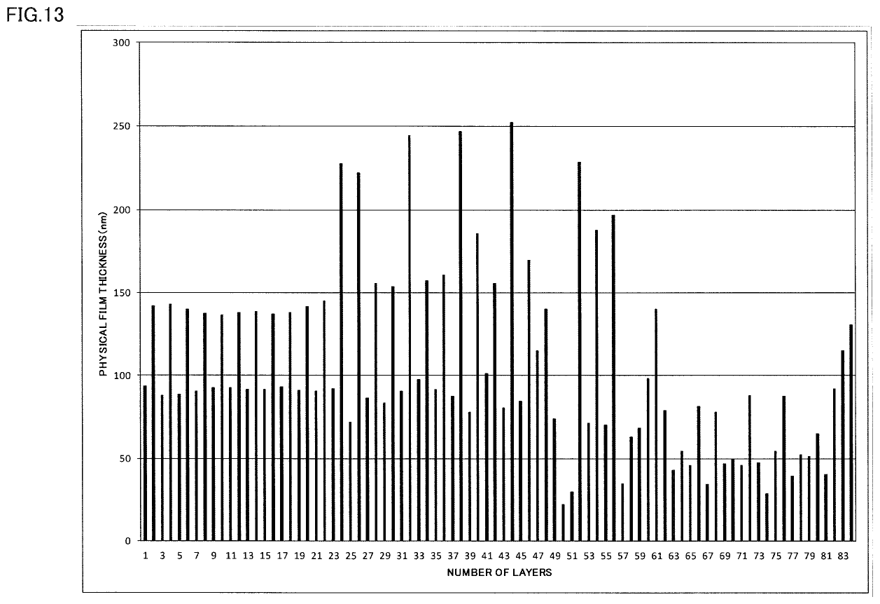

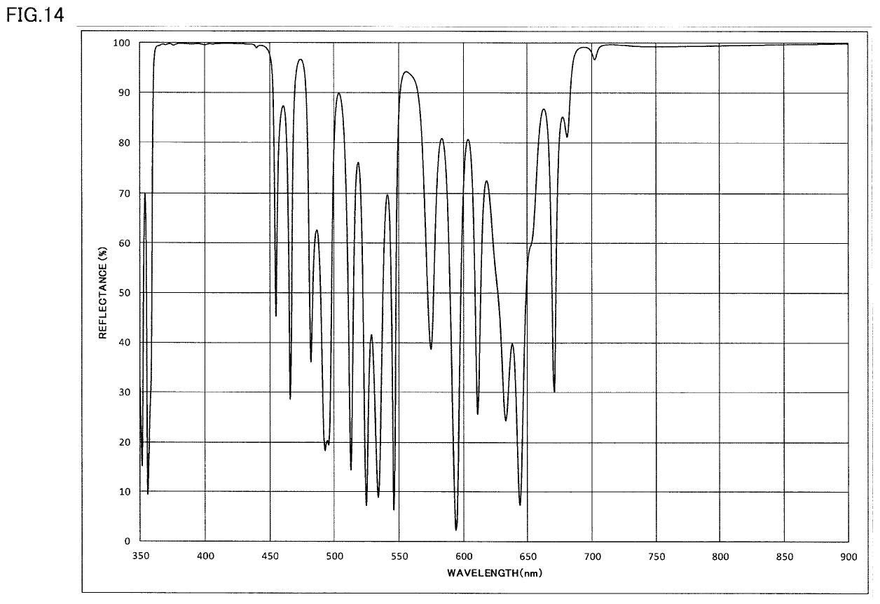

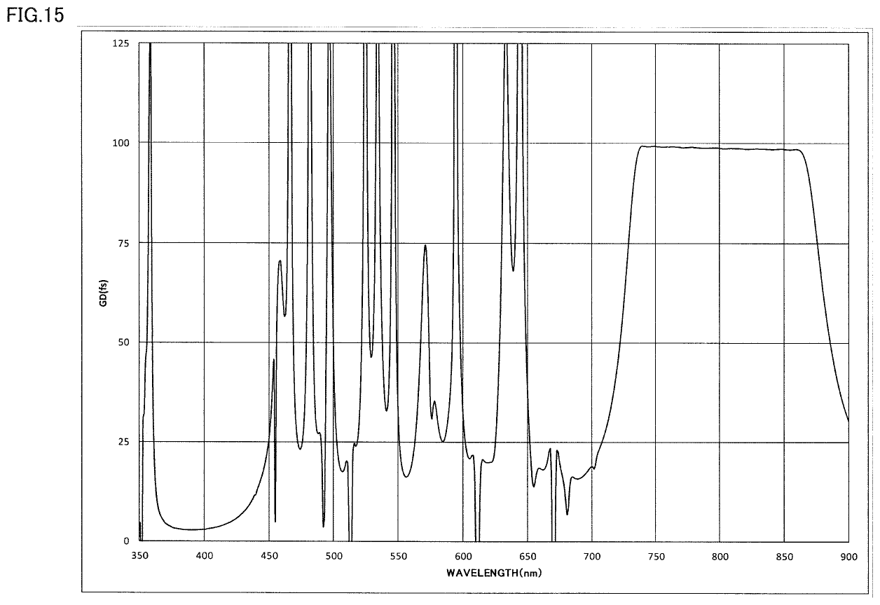

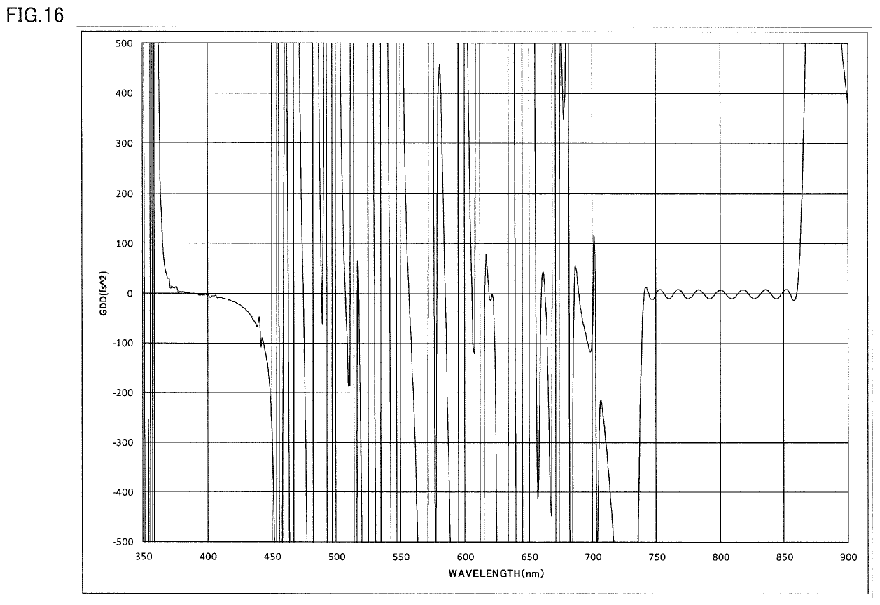

FIG. 13 to FIG. 16 are diagrams similar to FIG. 4 to FIG. 7, according to Example 3. It is noted that FIG. 14 to FIG. 16 are those obtained at an incidence angle of 5°, and the shown wavelength region is not less than 350 nm to 900 nm.

The optical multilayer film 4 of Example 3 is an alternate film in which odd number layers are Ta₂O₅ and even number layers are SiO₂, as in other Examples. The center wavelengths of Example 3 are 400 nm and 800 nm, as in Examples 1-1 to 2-2.

The total number of layers of the optical multilayer film 4 of Example 3 is 84.

Example 3 exhibits high reflection in a wavelength region (400 nm band) of not less than 360 nm and not greater than 455 nm, and in a wavelength region (800 nm band) of not less than 705 nm.

While the GD of Example 3 is about 4 fs in the 400 nm band, the GD is about 100 fs in the 800 nm band, and the difference of the latter relative to the former is about 96 fs.

The GDD of Example 3 is about 0 fs² in the 400 nm band and in the 800 nm band. In Example 3, low dispersion is realized at (in wavelength regions including) these wavelengths, and the shapes of both of the 400 nm band optical pulse and the 800 nm band optical pulse are not changed.

Example 3 serves as a low-dispersion delay mirror 1 that delays, through a single time of reflection of each optical pulse and without deforming the optical pulse, an 800 nm band optical pulse with respect to a 400 nm band optical pulse by about 96 fs. In Example 3, with respect to the 400 nm band optical pulse and the 800 nm band optical pulse, a time difference can be provided in a coaxial manner through reflection along the same optical path.

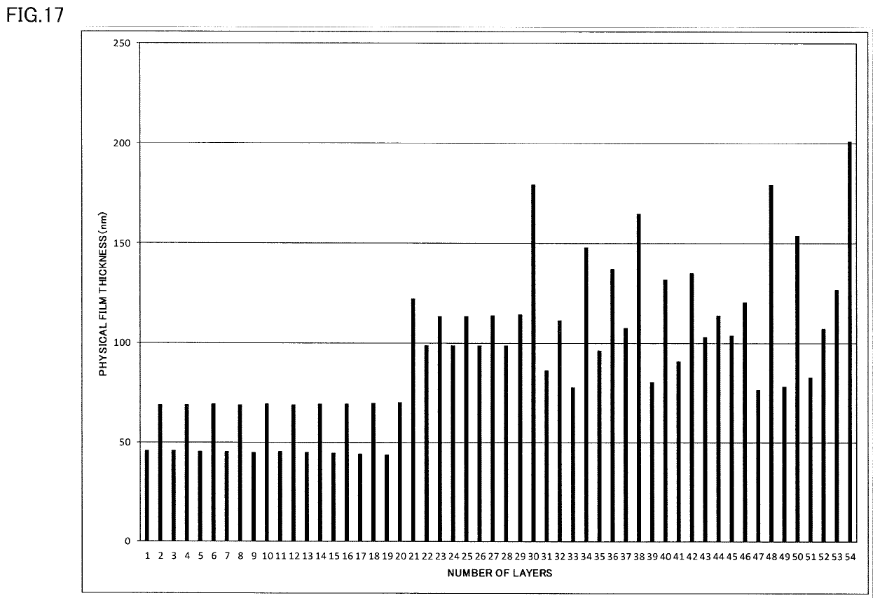

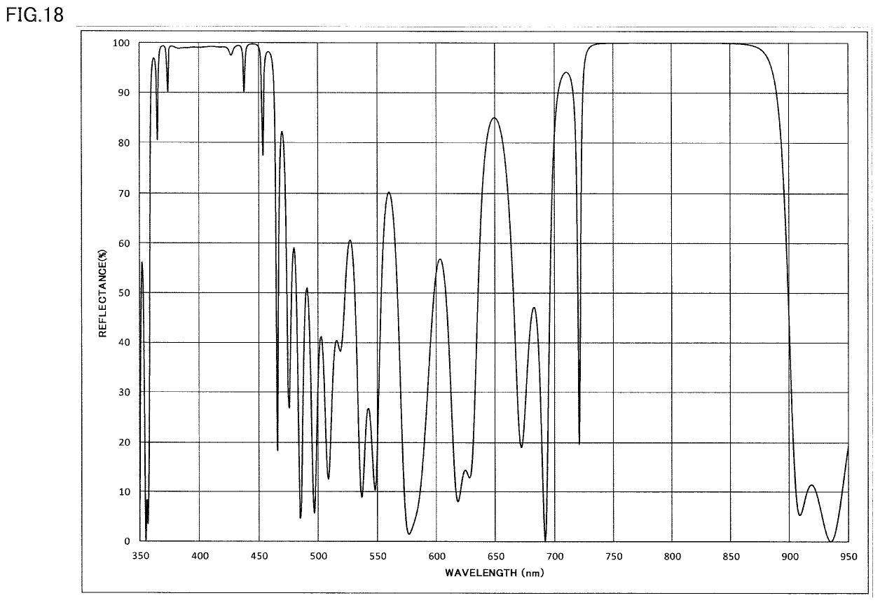

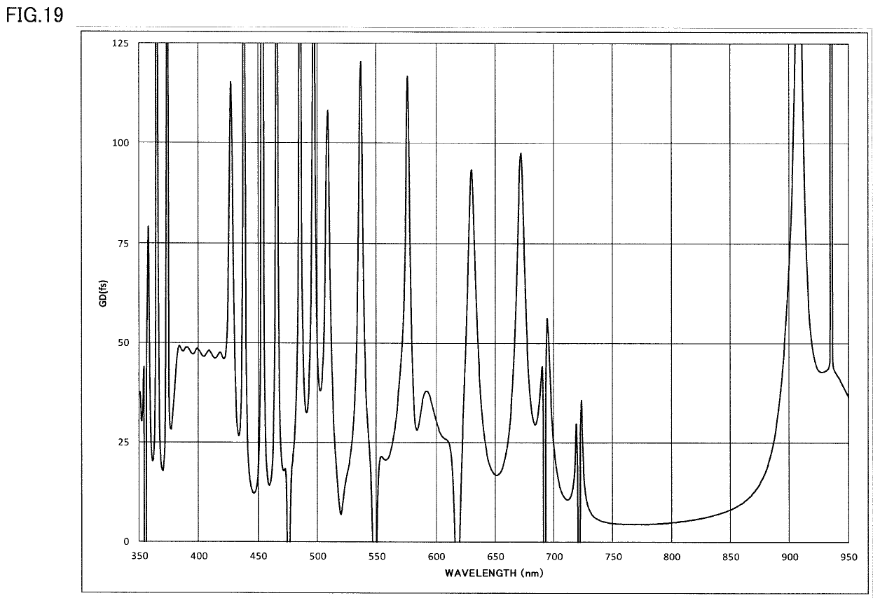

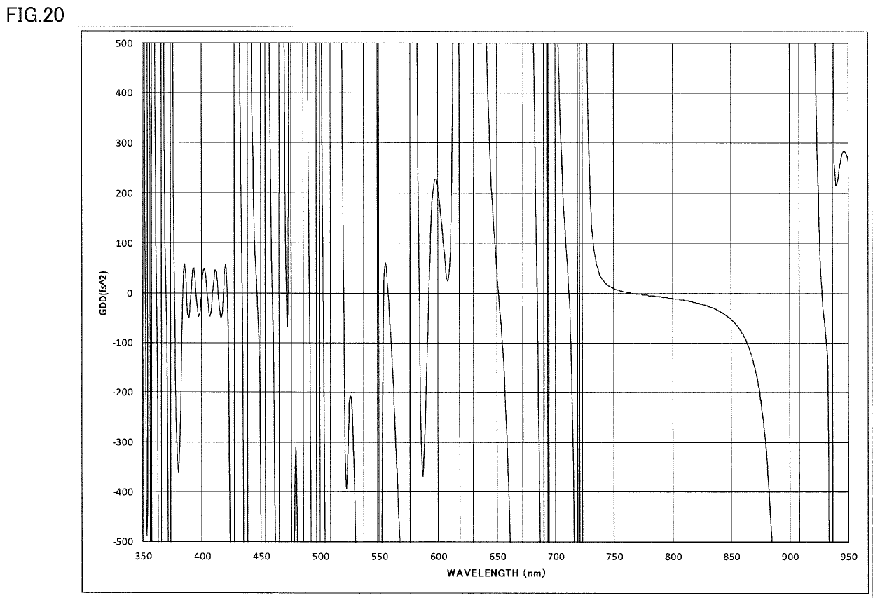

FIG. 17 to FIG. 20 are diagrams similar to FIG. 4 to FIG. 7, according to Example 4. It is noted that FIG. 18 to FIG. 20 are those obtained at an incidence angle of 5°, and the shown wavelength region is not less than 350 nm to 950 nm.

The optical multilayer film 4 of Example 4 is an alternate film in which odd number layers are Ta₂O₅ and even number layers are SiO₂, as in other Examples. The center wavelengths of Example 4 are 400 nm and 800 nm, as in Examples 1-1 to 3.

The total number of layers of the optical multilayer film 4 of Example 4 is 54.

Example 4 exhibits high reflection in a wavelength region (400 nm band) of not less than 370 nm and not greater than 430 nm, and in a wavelength region (800 nm band) of not less than 730 nm and not greater than 870 nm.

While the GD of Example 4 is about 49 fs in the 400 nm band, the GD is about 6 fs in the 800 nm band, and the difference of the latter relative to the former is about −43 fs.

The GDD of Example 4 is about 0 fs² in the 400 nm band and in the 800 nm band. In Example 4, low dispersion is realized at (in wavelength regions including) these wavelengths, and the shapes of both of the 400 nm band optical pulse and the 800 nm band optical pulse are not changed.

Example 4 serves as a low-dispersion delay mirror 1 that delays, through a single time of reflection of each optical pulse and without deforming the optical pulse, a 400 nm band optical pulse with respect to an 800 nm band optical pulse by about 43 fs. In Example 4, with respect to the 400 nm band optical pulse and the 800 nm band optical pulse, a time difference can be provided in a coaxial manner through reflection along the same optical path.

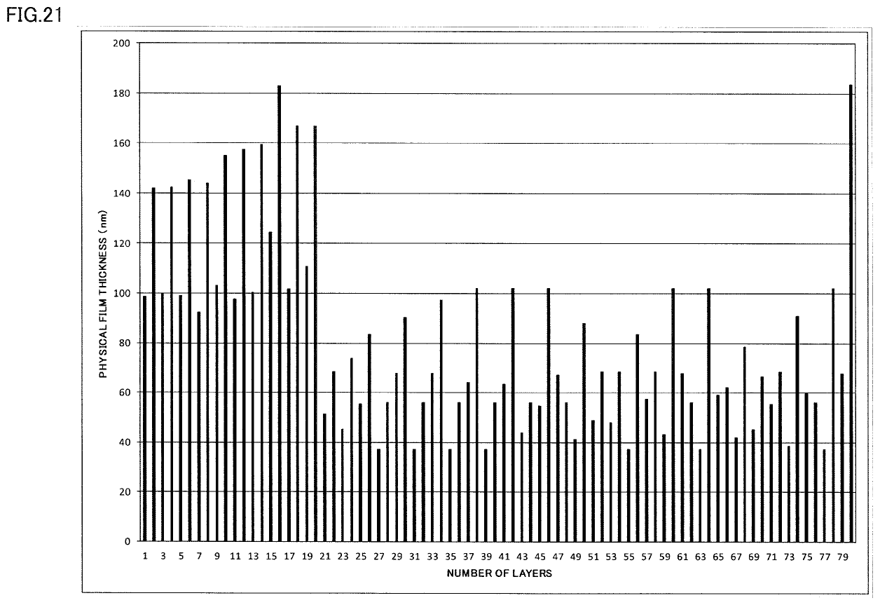

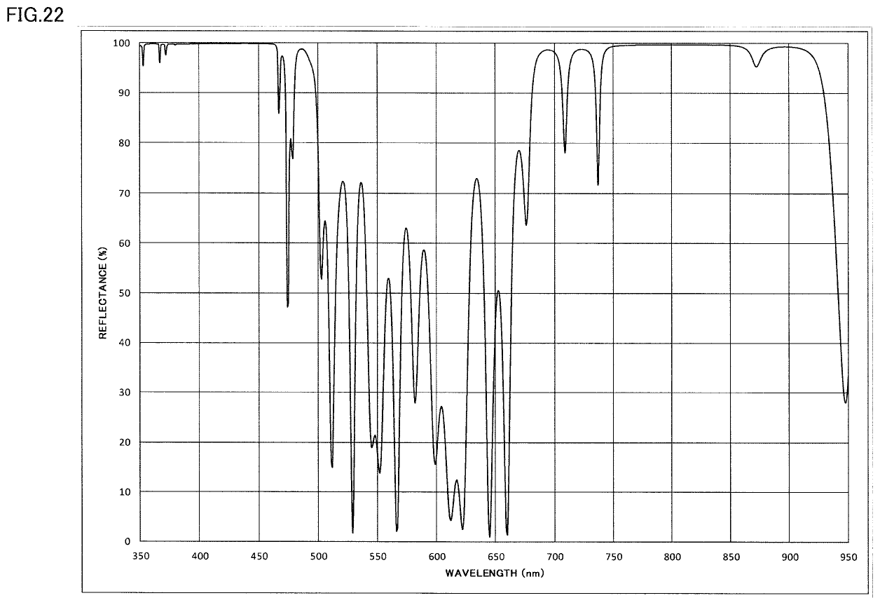

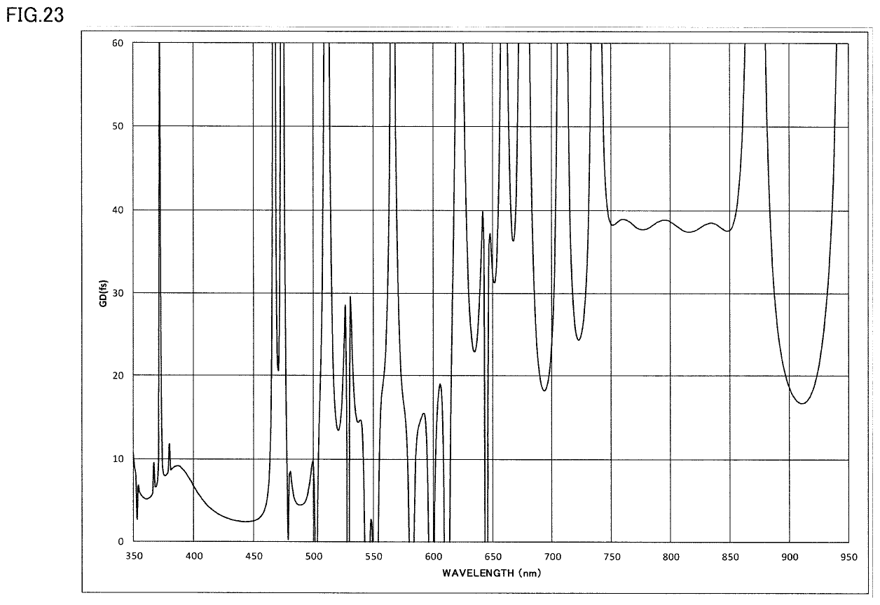

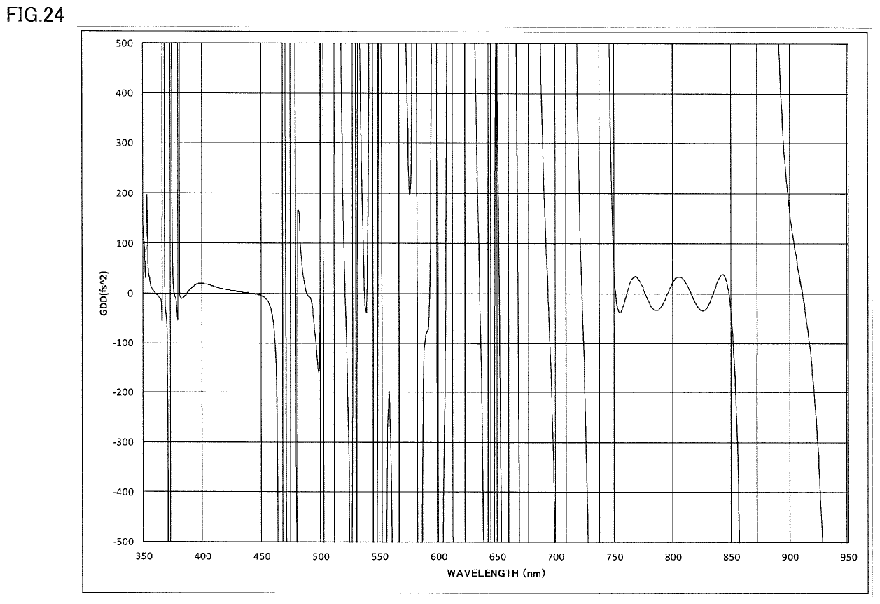

FIG. 21 to FIG. 24 are diagrams similar to FIG. 4 to FIG. 7, according to Example 5. It is noted that FIG. 22 to FIG. 24 are those obtained at an incidence angle of 45° according to s-polarized light, and the shown wavelength region is not less than 350 nm to 950 nm.

The optical multilayer film 4 of Example 5 is an alternate film in which odd number layers are Ta₂O₅ and even number layers are SiO₂, as in other Examples. The center wavelengths of Example 5 are 400 nm and 800 nm, as in Examples 1-1 to 4.

The total number of layers of the optical multilayer film 4 of Example 5 is 80.

Example 5 exhibits high reflection in a wavelength region (400 nm band) of not less than 375 nm and not greater than 470 nm, and in a wavelength region (800 nm band) of not less than 750 nm and not greater than 850 nm.

While the GD of Example 5 is about 7 fs in the 400 nm band, the GD is about 39 fs in the 800 nm band, and the difference of the latter relative to the former is about 32 fs.

The GDD of Example 5 is about 0 fs² in the 400 nm band and in the 800 nm band. In Example 5, low dispersion is realized at (in wavelength regions including) these wavelengths, and the shapes of both of the 400 nm band optical pulse and the 800 nm band optical pulse are not changed.

Example 5 serves as a low-dispersion delay mirror 1 that delays, through a single time of reflection of each optical pulse having been s-polarized and without deforming the optical pulse according to s-polarization, a 400 nm band optical pulse with respect to an 800 nm band optical pulse by about 32 fs. In Example 5, with respect to the 400 nm band optical pulse and the 800 nm band optical pulse according to s-polarization, a time difference can be provided in a coaxial manner through reflection along the same optical path.

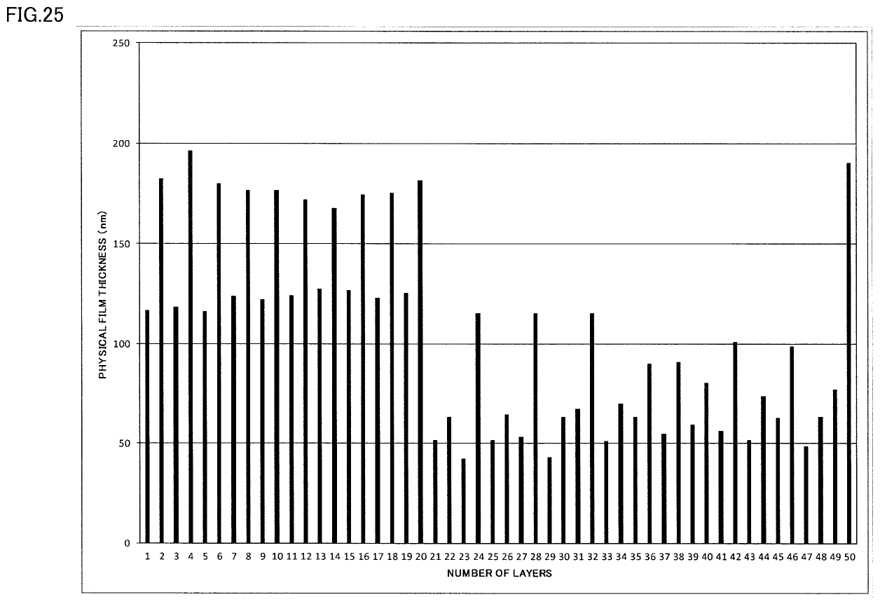

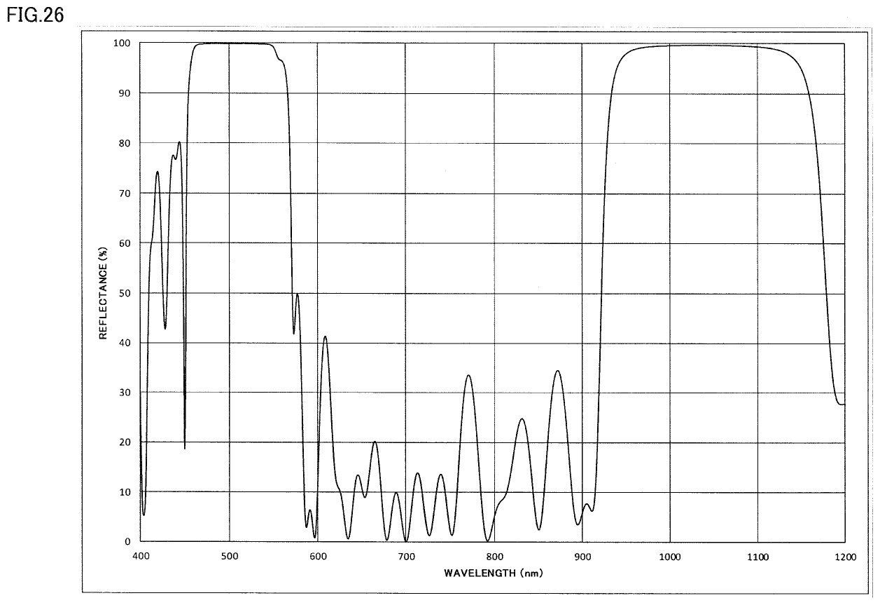

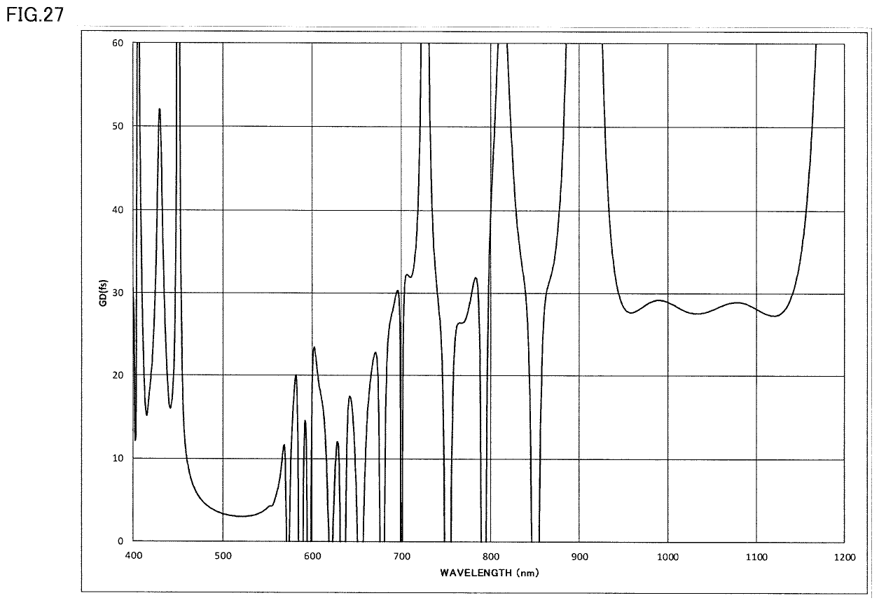

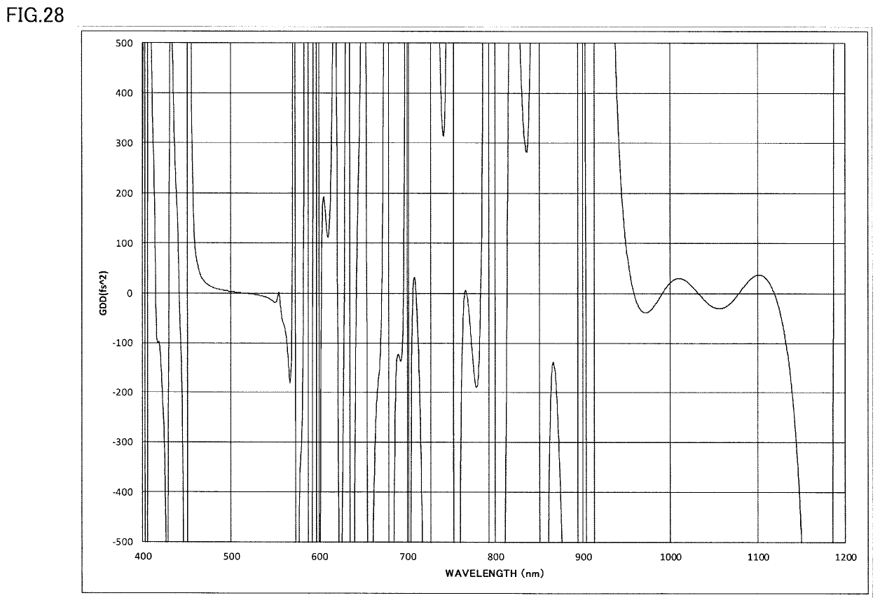

FIG. 25 to FIG. 28 are diagrams similar to FIG. 4 to FIG. 7 according to Example 6. It is noted that FIG. 26 to FIG. 28 are those obtained at an incidence angle of 5°, and the shown wavelength region is not less than 400 nm to 1200 nm.

The optical multilayer film 4 of Example 6 is an alternate film in which odd number layers are Ta₂O₅ and even number layers are SiO₂, as in other Examples. The center wavelengths of Example 6 are 515 nm and 1030 nm, which are different from those in Examples 1-1 to 5.

The total number of layers of the optical multilayer film 4 of Example 6 is 50.

Example 6 exhibits high reflection in a wavelength region (515 nm band) of not less than 460 nm and not greater than 550 nm, and in a wavelength region (1030 nm band) of not less than 980 nm and not greater than 1100 nm.

While the GD of Example 6 is about 3 fs in the 515 nm band, the GD is about 28 fs in the 1030 nm band, and the difference of the latter relative to the former is about 25 fs.

The GDD of Example 6 is about 0 fs² at 515 nm and at 1030 nm. In Example 6, low dispersion is realized at (in wavelength regions including) these wavelengths, and the shapes of both of the 515 nm band optical pulse and the 1030 nm band optical pulse are not changed.

Example 6 serves as a low-dispersion delay mirror 1 that delays, through a single time of reflection of each optical pulse and without deforming the optical pulse, the 1030 nm band optical pulse with respect to the 515 nm band optical pulse by about 25 fs. In Example 6, with respect to the 515 nm band optical pulse and the 1030 nm band optical pulse, a time difference can be provided in a coaxial manner through reflection along the same optical path.

The optical multilayer film 4 of Example 7 is designed to be used in a case where, with respect to a fundamental wave (800 nm band) and a second harmonic (400 nm band) of a titanium sapphire laser, dispersion compensation for these is performed, and the fundamental wave is delayed with respect to the second harmonic. It is noted that at least one of the wavelength band to which the wavelength of the fundamental wave belongs and the wavelength band to which the wavelength of the second harmonic belongs may be changed from the 800 nm band and the 400 nm band. Further, a laser other than the titanium sapphire laser may be used.

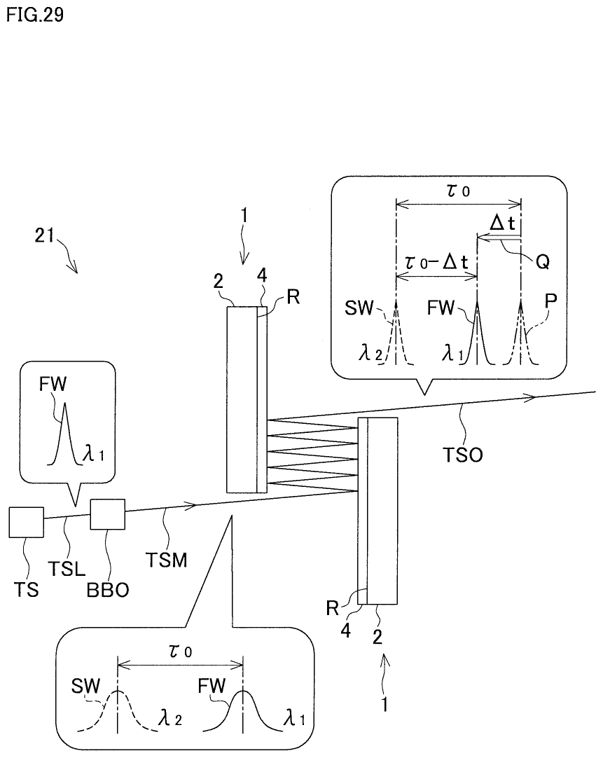

FIG. 29 is a schematic diagram of this case (laser system 21).

The laser system 21 has a titanium sapphire laser light source TS, a nonlinear optical crystal BBO, and two delay mirrors 1 (Example 7) which partially face each other and which are the same as those in the delay mirror system 11.

Laser light TSL (here, a wavelength λ₁ of the fundamental wave FW is 800 nm) including only the fundamental wave FW emitted from the titanium sapphire laser light source TS enters the nonlinear optical crystal BBO. The nonlinear optical crystal BBO generates a second harmonic SW having a wavelength (λ₂=400 nm) being half of that of the fundamental wave FW, and emits mixed light TSM in which the fundamental wave FW and the second harmonic SW are mixed. In the mixed light TSM, the second harmonic SW is delayed with respect to the fundamental wave FW by a delay time τ₀. The mixed light TSM is reflected by the pair of delay mirrors 1 a predetermined number of times, to become output light TSO. In a case where the delay mirrors 1 do not delay a 400 nm band optical pulse and delay an 800 nm band optical pulse, and if the latter is delayed with respect to the former by a time difference Δt due to the predetermined number of times of reflection, the fundamental wave FW is delayed (see the double arrow Q in FIG. 29), in the output light TSO, by a time difference Δt with respect to a state (see the two-dot chain line P in FIG. 29) where the fundamental wave FW precedes the second harmonic SW by a delay time τ₀ in the mixed light TSM, and the second harmonic SW is delayed with respect to the fundamental wave FW by an adjusted delay time τ₀-Δt. Similarly, when the 400 nm band optical pulse is delayed by a smaller extent with respect to the 800 nm band optical pulse, it can be considered that the former is relatively delayed with respect to the latter by the time difference Δt due to a predetermined number of times of reflection, and the fundamental wave FW is delayed with respect to the second harmonic SW from the state of the mixed light TSM by an adjusted delay time τ₀-Δt.

Group velocity of light passing through the inside of the nonlinear optical crystal BBO is wavelength-dependent. Therefore, in the fundamental wave FW and the second harmonic SW passing through the nonlinear optical crystal BBO, a shift in the speed of light for each wavelength, i.e., a chirp, occurs. Due to generation of such a chirp, the pulse widths of the optical pulses forming the fundamental wave FW and the second harmonic SW are broadened or the peak intensities decrease.

It is noted that when the wavelength is defined as λ (nm), the refractive index of a medium being a function of the wavelength λ is defined as n (k), and the light velocity is defined as c (nm/fs), the group velocity V_{g} (nm/fs) is represented by the following formula (5).

$${V}_{g} = \frac{c}{n ( λ ) - λ \frac{\partial n}{\partial λ}} \qquad ( 5 )$$

Then, as an index for the shift of the group velocity, a group velocity dispersion (fs²/cm) represented by the following formula (6) is used. “Group velocity dispersion” is hereinafter referred to as GVD. The GVD is related to the slope of the group velocity. If the GVD=0, the group velocity has no wavelength-dependency, and no chirp occurs in the optical pulse propagating in the medium. On the other hand, when the group velocity dispersion GVD≠0, the group velocity has wavelength-dependency, and a chirp occurs in the optical pulse propagating in the medium having the GVD≠0.

$$GVD = \frac{\partial {V}_{g}^{- 1}}{\partial ω} = \frac{{λ}^{2}}{2 π {cV}_{g}^{2}} \frac{\partial {V}_{g}}{\partial λ} \qquad ( 6 )$$

Dispersion compensation performed when an optical pulse having passed through a predetermined propagation path is reflected by the delay mirrors 1 of Example 7 is maximized when the following formula (7) is satisfied.

Here, i is a number provided for each kind of medium in the propagation path. When the nonlinear optical crystal BBO and air are present in the propagation path, i=1 (the nonlinear optical crystal BBO) and i=2 (air), for example. Further, GVD₁ is the GVD of the nonlinear optical crystal BBO, and GVD₂ is the GVD of air. Further, a thickness₁ of a medium is the thickness (the path length in the nonlinear optical crystal BBO) of the nonlinear optical crystal BBO, and a thickness₂ of a medium is the thickness (the path length in air) of air.

That is, when the delay mirror 1 of Example 7 is configured to have a GDD with which the GVD in the entirety of the propagation path is canceled, dispersion compensation is realized.

$${\sum }_{i} ( {GVD}_{i} \times {thickness}_{i} of medium ) + GDD = 0 \qquad ( 7 )$$

In a wavelength region of not less than 400 nm to 1200 nm, both of the GVD₁ of the nonlinear optical crystal BBO and the group velocity dispersion GVD₂ of air monotonously decrease. The GVD₁, that is representative, of the nonlinear optical crystal BBO with respect to light having a wavelength of 400 nm is 2100 fs²/cm, the GVD₁ of the nonlinear optical crystal BBO with respect to light having a wavelength of 800 nm is 1000 fs²/cm, the GVD₂ of air with respect to light having a wavelength of 800 nm is 0.21 fs²/cm, and these are in similar orders also for other wavelengths. Therefore, the GVD₁ of the nonlinear optical crystal BBO is about 10000-fold of the GVD₂ of air, and roughly saying, the GVD₁ during advancement by 0.1 mm in the nonlinear optical crystal BBO and the GVD₂ during advancement by 1 m (meter) in air are substantially the same with each other.

The propagation path is determined by the laser light TSL, the nonlinear optical crystal BBO, the mixed light TSM, the path between both delay mirrors 1, and the output light TSO. The GDD in the delay mirror 1 of Example 7 can be determined so as to be dispersion-compensated in the laser system 21. Alternatively, when the product of the GVD₂ of air and the thickness 2 of medium being air is sufficiently small, the GDD in the delay mirror 1 of Example 7 may be determined by the GVD₁ of the nonlinear optical crystal BBO× the thickness₁ of the medium.

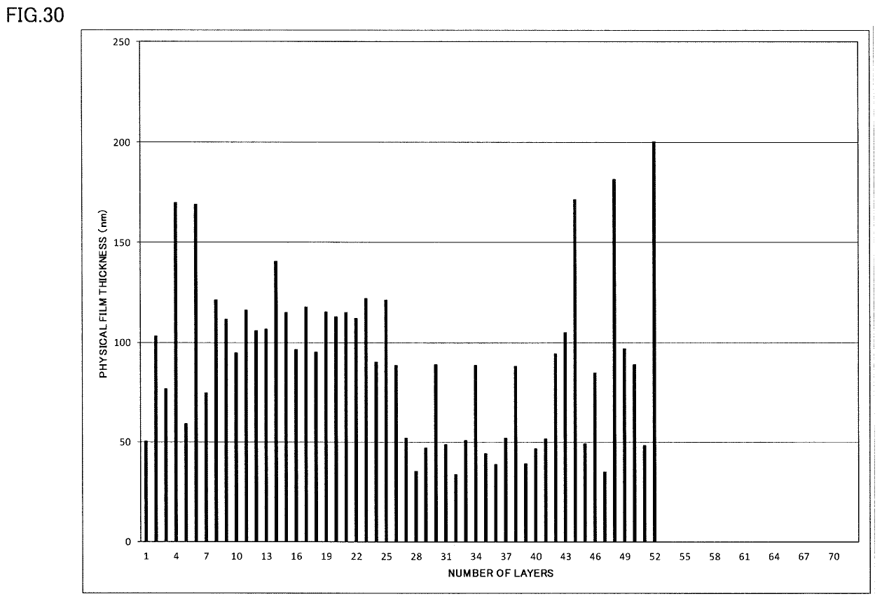

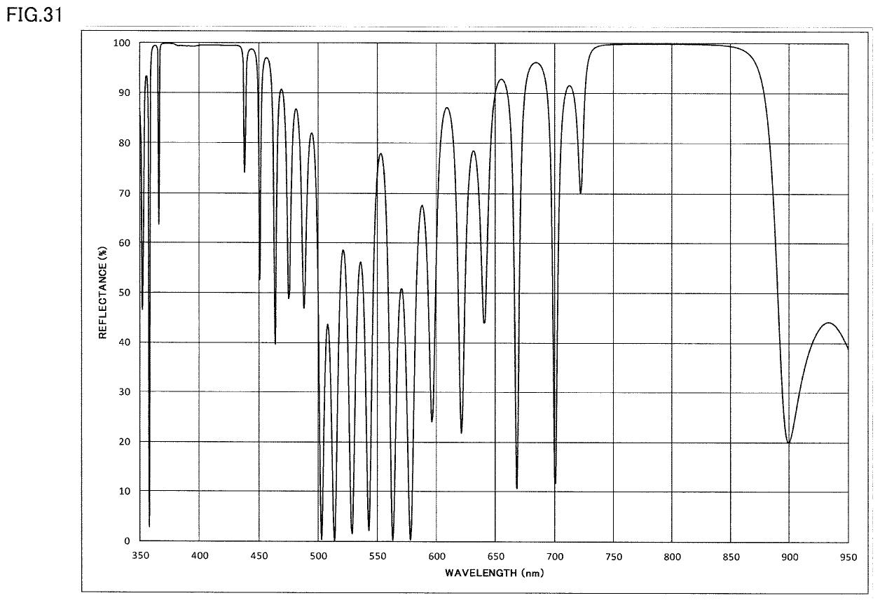

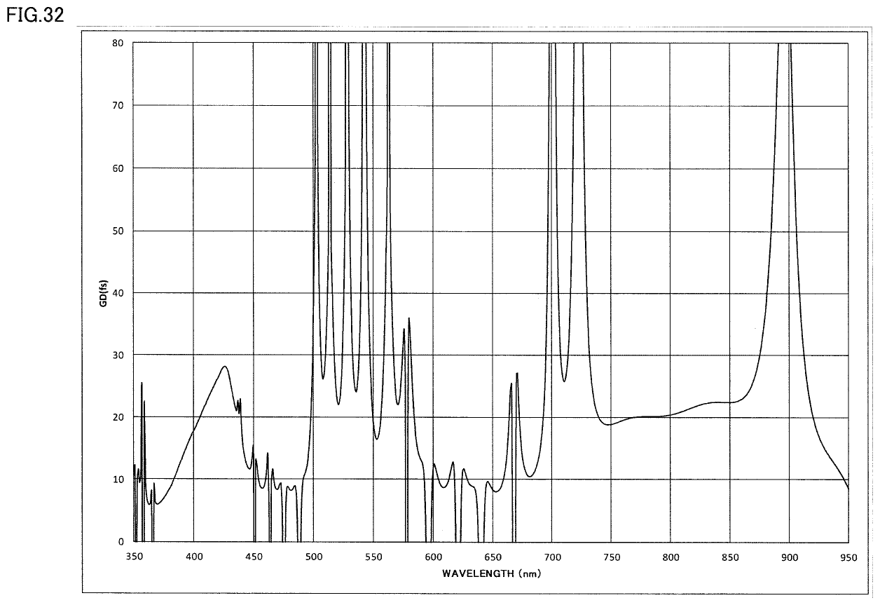

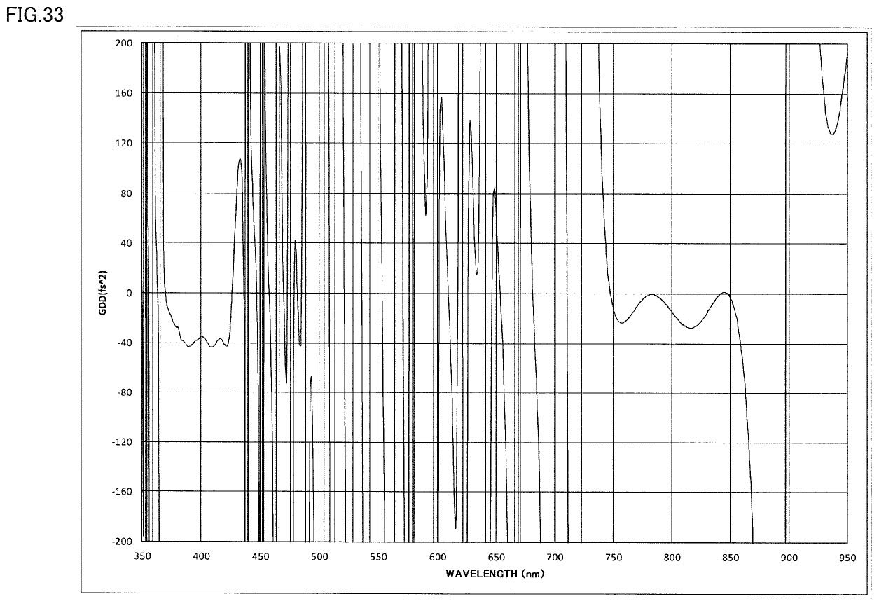

FIG. 30 to FIG. 33 are diagrams similar to FIG. 4 to FIG. 7, according to Example 7. FIG. 31 to FIG. 33 are those obtained at an incidence angle of 5°.

The optical multilayer film 4 of Example 7 is an alternate film in which odd number layers are Ta₂O₅ and even number layers are SiO₂, as in other Examples. The center wavelengths of Example 7 are 400 nm and 800 nm, as in Examples 1-1 to 5.

The total number of layers of the optical multilayer film 4 of Example 7 is 52.

Example 7 exhibits high reflection in a wavelength region (400 nm band) of not less than 370 nm and not greater than 435 nm, and in a wavelength region (800 nm band) of not less than 730 nm and not greater than 850 nm.

While the of Example 7 is about 18 fs in the 400 nm band, the GD is about 20.7 fs in the 800 nm band, and the difference of the latter relative to the former is about 2.7 fs. In Example 7, through ten times of reflection of each optical pulse, the 800 nm band optical pulse is delayed by 2.7×10=27 fs with respect to the 400 nm band optical pulse.

The GDD of Example 7 is about −40 fs² in the 400 nm band, and is about −15 fs² in the 800 nm band. Example 7 has negative dispersions, suitable for dispersion compensation, in the 400 nm band and the 800 nm band, respectively, in ten times of reflection.

The pair of Examples 7 is configured such that: as a result of a total of ten times of reflection of each optical pulse, the fundamental wave FW and the second harmonic SW in which chirps have occurred in the mixed light TSM are restored through dispersion compensation to those before the entry into the nonlinear optical crystal BBO; and further, the fundamental wave FW including an 800 nm band optical pulse is delayed by about 27 fs with respect to the second harmonic SW including a 400 nm band optical pulse (the time difference Δt in FIG. 29). In Example 7, with respect to the fundamental wave FW and the second harmonic SW, the time difference Δt and dispersion compensation can be provided in a coaxial manner through reflection along the same optical path. That is, the delay mirror 1 of Example 7 has a dispersion compensation function for the fundamental wave FW and the second harmonic SW, in addition to a delay function for the fundamental wave FW and the second harmonic SW.

It is noted that the number of times of reflection is not limited to 10. This also applies hereafter.

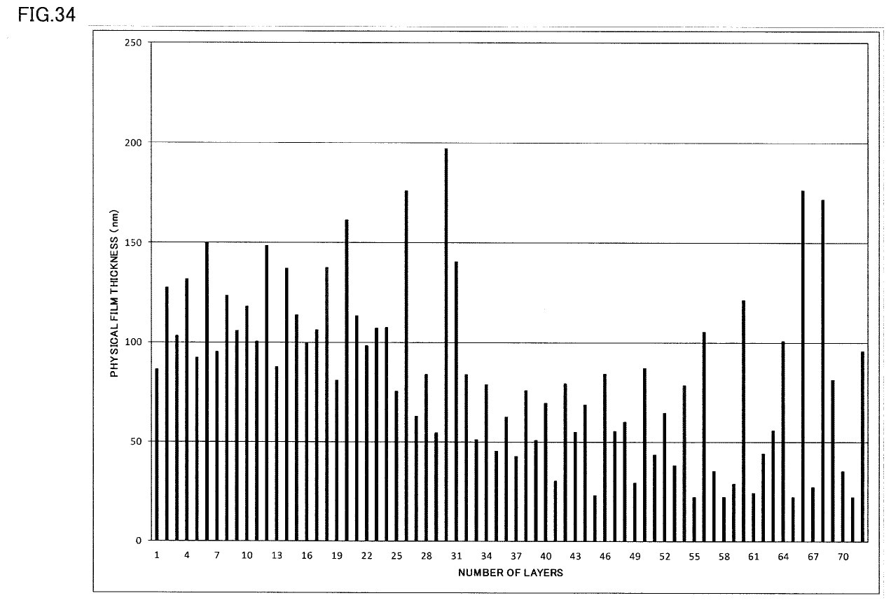

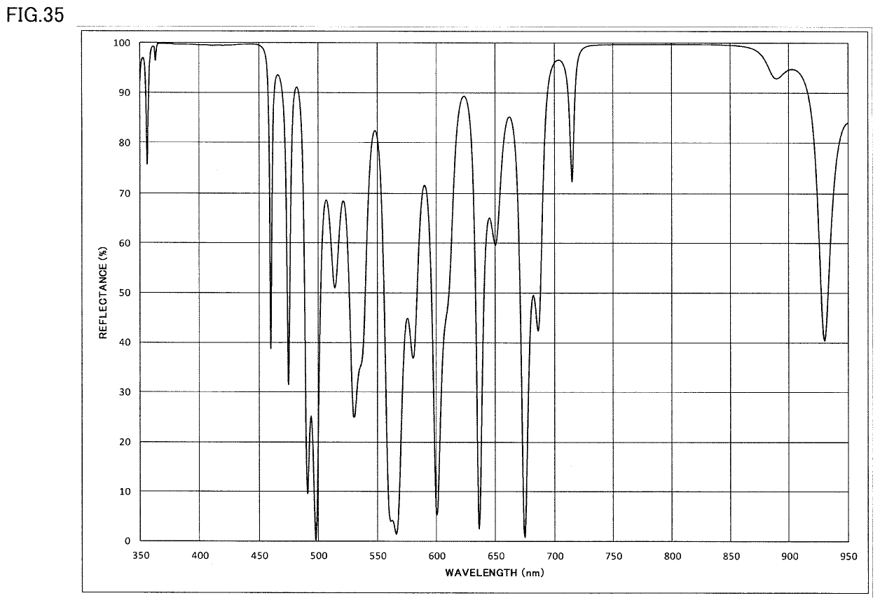

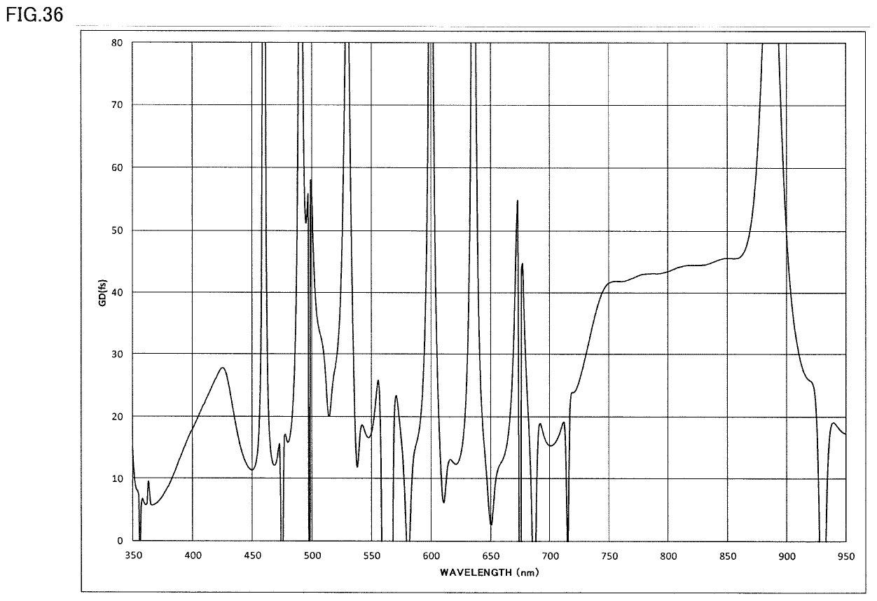

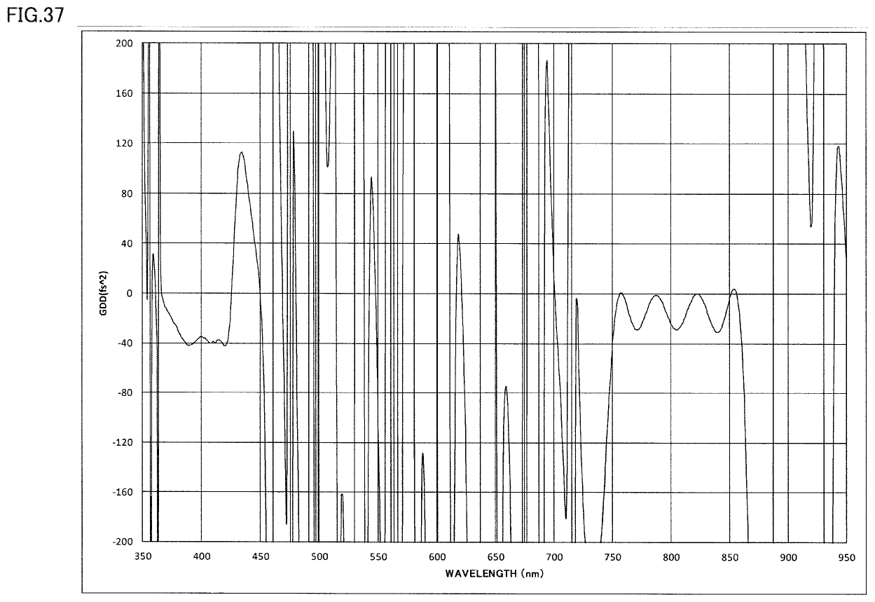

FIG. 34 to FIG. 37 are diagrams similar to FIG. 4 to FIG. 7, according to Example 8. It is noted that FIG. 35 to FIG. 37 are those obtained at an incidence angle of 5°, and the shown wavelength region is not less than 350 nm to 950 nm.

The optical multilayer film 4 of Example 8 is an alternate film in which odd number layers are Ta₂O₅ and even number layers are SiO₂, as in other Examples. The center wavelengths of Example 8 are 400 nm and 800 nm, as in Examples 1-1 to 5 and 7.

The total number of layers of the optical multilayer film 4 of Example 8 is 72.

Similar to Example 7, in Example 8, delay and dispersion compensation are performed.

Example 8 exhibits high reflection in a wavelength region (400 nm band) of not less than 360 nm and not greater than 450 nm, and in a wavelength region (800 nm band) of not less than 725 nm and not greater than 850 nm.

While the of Example 8 is about 18 fs in the 400 nm band, the GD is about 44 fs in the 800 nm band, and the difference of the latter relative to the former is about 26 fs. In Example 8, through ten times of reflection of each optical pulse, the 800 nm band optical pulse is delayed by about 26×10=about 260 fs with respect to the 400 nm band optical pulse.

The GDD of Example 8 is about −40 fs² in the 400 nm band, and is about −15 fs² in the 800 nm band. Example 8 has negative dispersions, suitable for dispersion compensation, in the 400 nm band and the 800 nm band, respectively, in ten times of reflection.

The pair of Examples 8 is configured such that: as a result of a total of ten times of reflection of each optical pulse, the fundamental wave FW and the second harmonic SW in which chirps have occurred are subjected to dispersion compensation; and further, the fundamental wave FW is delayed by about 260 fs with respect to the second harmonic SW. In Example 8, with respect to the fundamental wave FW and the second harmonic SW, a time difference and dispersion compensation can be provided in a coaxial manner through reflection along the same optical path.

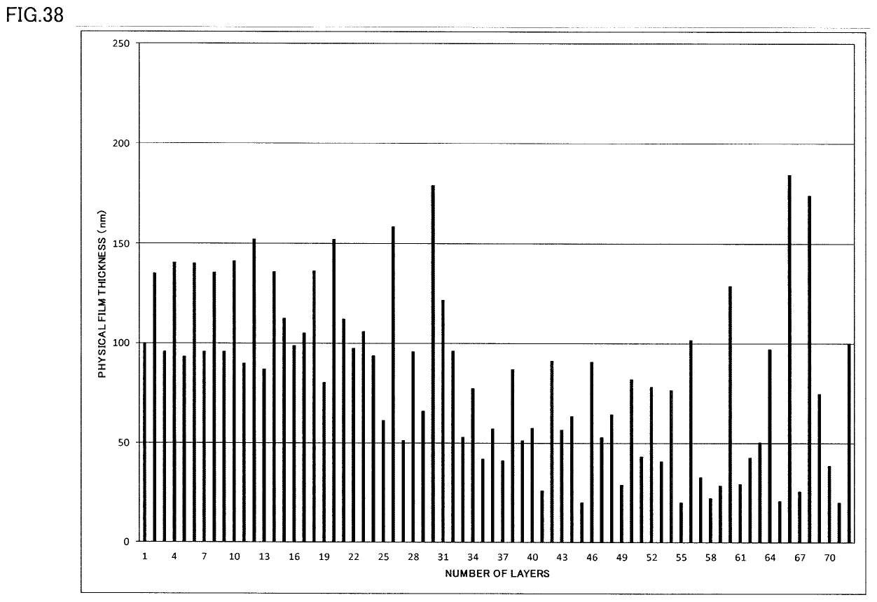

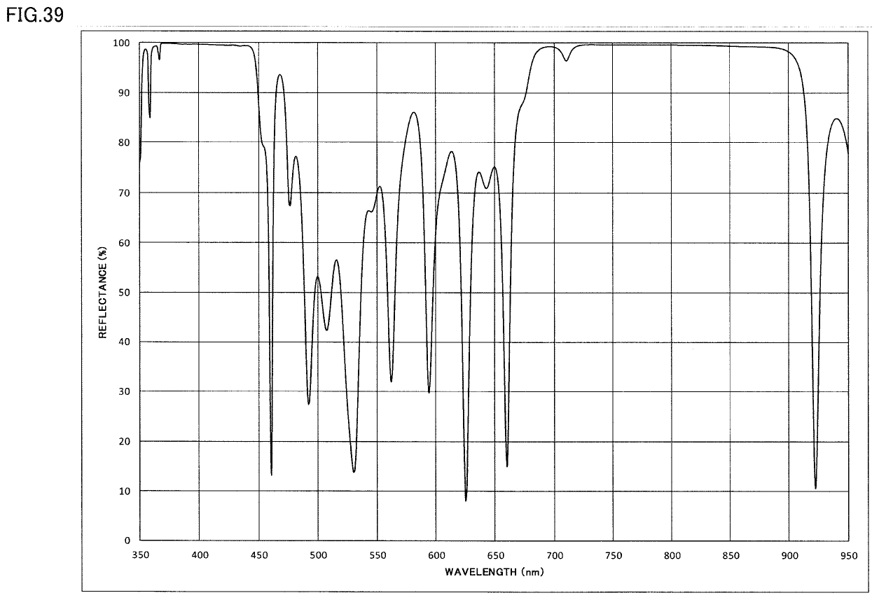

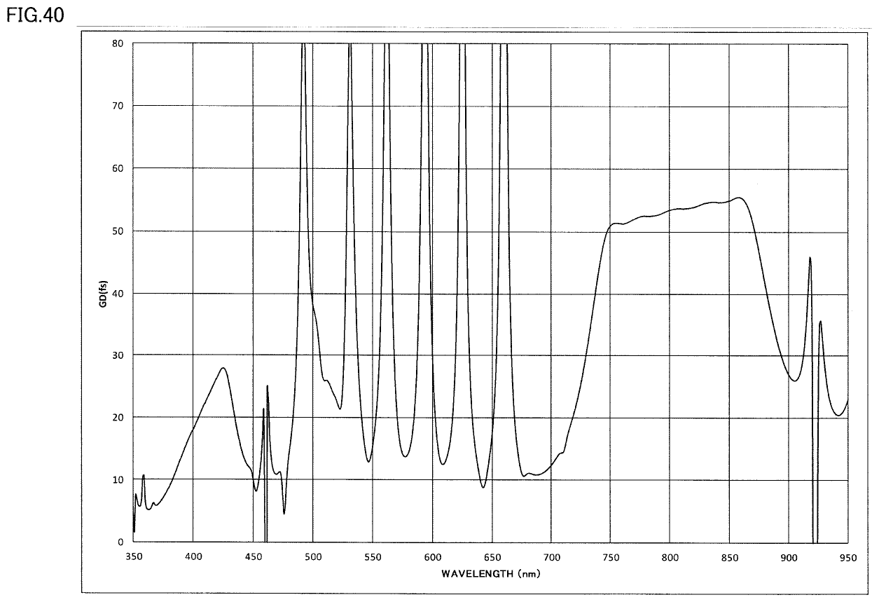

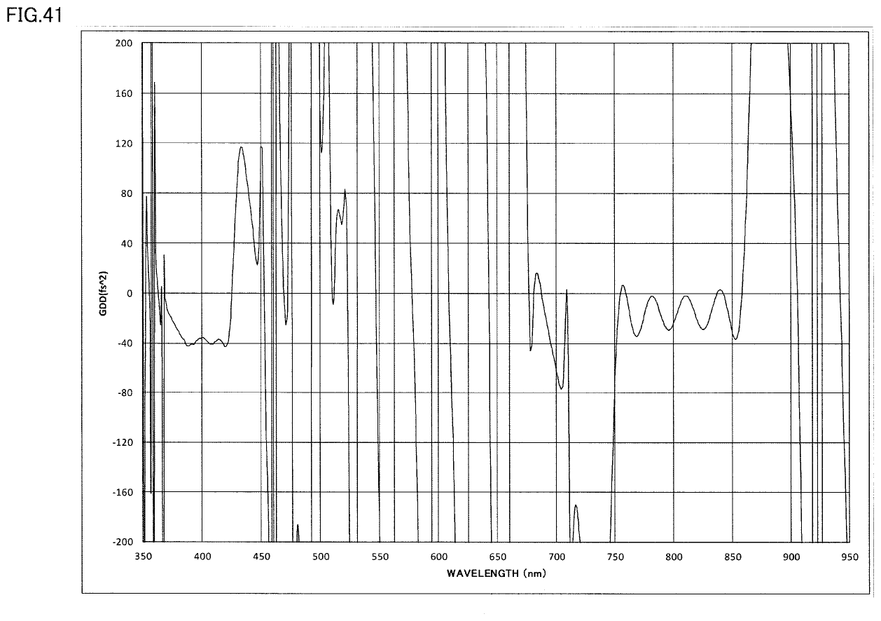

FIG. 38 to FIG. 41 are diagrams similar to FIG. 4 to FIG. 7, according to Example 9. It is noted that FIG. 39 to FIG. 41 are those obtained at an incidence angle of 5°, and the shown wavelength region is not less than 350 nm to 950 nm.

The optical multilayer film 4 of Example 9 is an alternate film in which odd number layers are Ta₂O₅ and even number layers are SiO₂, as in other Examples. The center wavelengths of Example 9 are 400 nm and 800 nm, as in Examples 1-1 to 5 and 7 to 8.

The total number of layers of the optical multilayer film 4 of Example 9 is 72.

Similar to Examples 7 and 8, in Example 9, delay and dispersion compensation are performed.

Example 9 exhibits high reflection in a wavelength region (400 nm band) of not less than 370 nm and not greater than 440 nm, and in a wavelength region (800 nm band) of not less than 720 nm and not greater than 900 nm.

While the of Example 9 is about 18 fs in the 400 nm band, the GD is about 53 fs in the 800 nm band, and the difference of the latter relative to the former is about 35 fs. In Example 9, through ten times of reflection of each optical pulse, the 800 nm band optical pulse is delayed by about 35×10=about 350 fs with respect to the 400 nm band optical pulse.

The GDD of Example 9 is about −40 fs² in the 400 nm band, and is about −15 fs² in the 800 nm band. Example 9 has negative dispersions, suitable for dispersion compensation, in the 400 nm band and the 800 nm band, respectively, in ten times of reflection.

The pair of Examples 9 is configured such that: as a result of a total of ten times of reflection of each optical pulse, the fundamental wave FW and the second harmonic SW in which chirps have occurred are subjected to dispersion compensation; and further, the fundamental wave FW is delayed by about 350 fs with respect to the second harmonic SW. In Example 9, with respect to the fundamental wave FW and the second harmonic SW, a time difference and dispersion compensation can be provided in a coaxial manner through reflection along the same optical path.

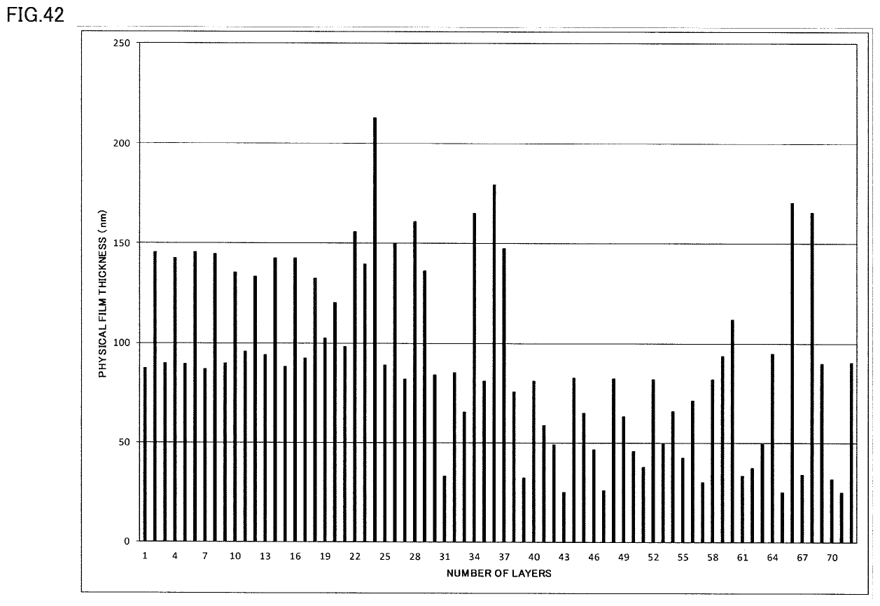

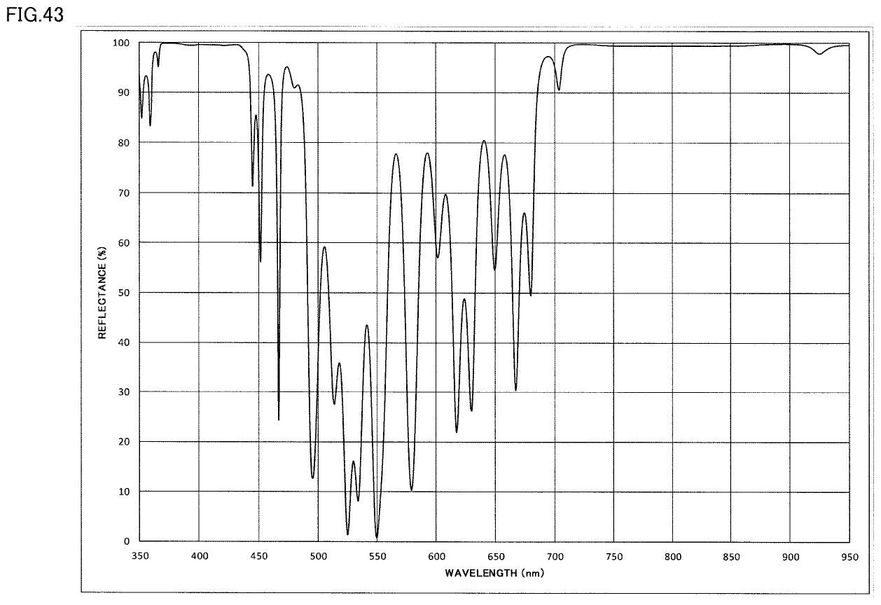

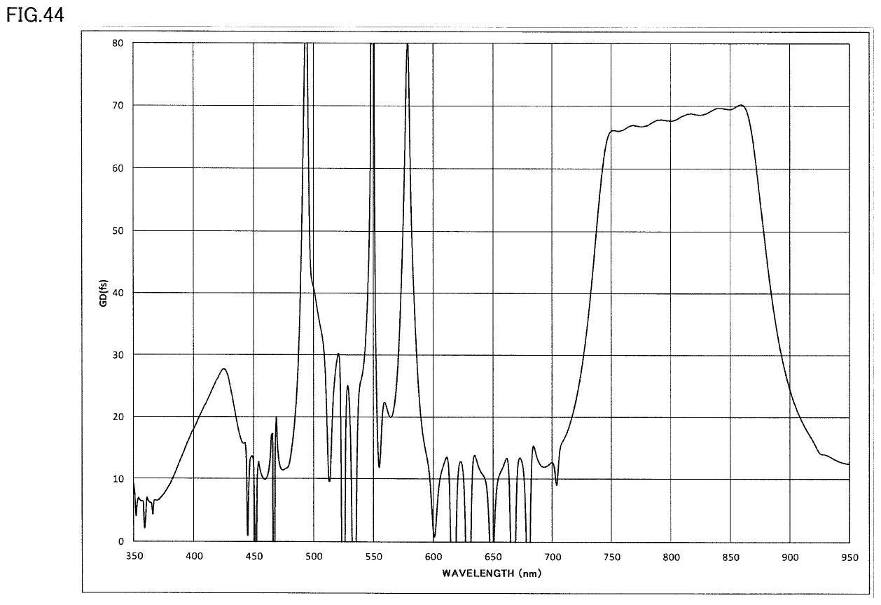

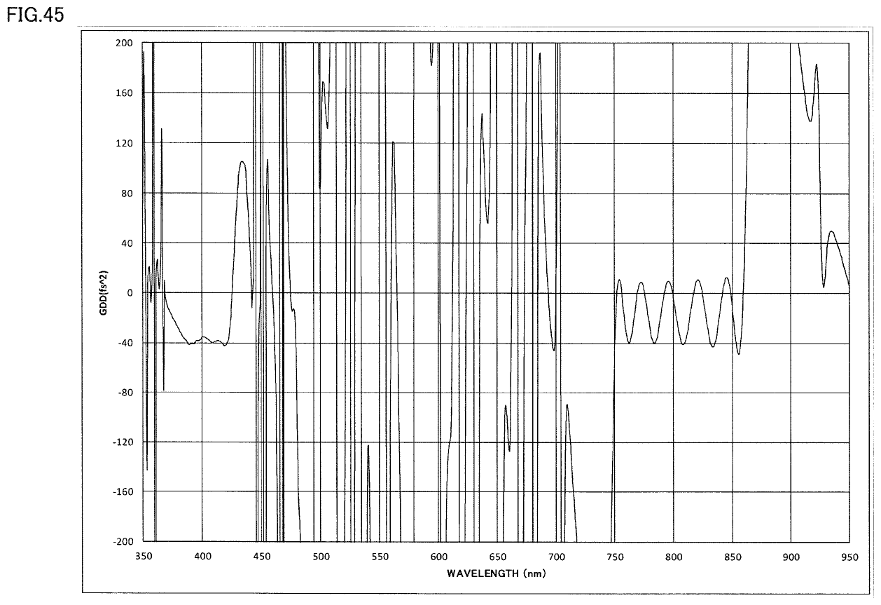

FIG. 42 to FIG. 45 are diagrams similar to FIG. 4 to FIG. 7, according to Example 10. It is noted that FIG. 43 to FIG. 45 are those obtained at an incidence angle of 5°, and the shown wavelength region is not less than 350 nm to 950 nm.

The optical multilayer film 4 of Example 10 is an alternate film in which odd number layers are Ta₂O₅ and even number layers are SiO₂, as in other Examples. The center wavelengths of Example 10 are 400 nm and 800 nm, as in Examples 1-1 to 5 and 7 to 9.

The total number of layers of the optical multilayer film 4 of Example 10 is 72.

Similar to Examples 7 to 9, in Example 10, delay and dispersion compensation are performed.

Example 10 exhibits high reflection in a wavelength region (400 nm band) of not less than 365 nm and not greater than 430 nm, and in the wavelength region (800 nm band) of not less than 715 nm.

While the GD of Example 10 is about 18 fs in the 400 nm band, the GD is about 68 fs in the 800 nm band, and the difference of the latter relative to the former is about 50 fs. In Example 10, through ten times of reflection of each optical pulse, the 800 nm band optical pulse is delayed by about 50×10=about 500 fs with respect to the 400 nm band optical pulse.

The GDD of Example 10 is about −40 fs² in the 400 nm band, and is about −15 fs² in the 800 nm band. Example 10 has negative dispersions, suitable for dispersion compensation, in the 400 nm band and the 800 nm band, respectively, in ten times of reflection.

The pair of Examples 10 is configured such that: as a result of a total ten times of reflection of each optical pulse, the fundamental wave FW and the second harmonic SW in which chirps have occurred are subjected to dispersion compensation; and further, the fundamental wave FW is delayed by about 500 fs with respect to the second harmonic SW. In Example 10, with respect to the fundamental wave FW and the second harmonic SW, a time difference and dispersion compensation can be provided in a coaxial manner through reflection along the same optical path.

The delay mirrors 1 according to these Examples delay a first optical pulse having a first wavelength band, by a predetermined delay time, with respect to a second optical pulse having a the second wavelength band, through reflection of these optical pulses at the optical multilayer films 4. The first optical pulse and the second optical pulse may be coaxial.

Further, the delay mirrors 1 of Examples 1-1 to 6 do not change (low dispersion) the shapes of the first optical pulse and the second optical pulse.

That is, each of the delay mirrors 1 of Examples 1-1 to 6 includes the base 2, and the optical multilayer film 4 formed on the surface R of the base 2. The value of the GD in a first wavelength band (800 nm band; 400 nm band in Example 4; 1030 nm band in Example 6) according to the optical multilayer film 4 is different from the value of the GD in a second wavelength band (400 nm band; 800 nm band in Example 4; 515 nm band in Example 6) according to the optical multilayer film 4. In addition, the value of the GDD in the first wavelength band according to the optical multilayer film 4 and the value of the GDD in the second wavelength band according to the optical multilayer film 4 are each not less than −100 fs² and not greater than 100 fs². Therefore, each of Examples 1-1 to 6 provides a delay mirror 1: that provides a time difference without substantially changing the shapes of a plurality of optical pulses of which the pulse widths are each not less than about 40 fs; that can process the plurality of optical pulses in a coaxial manner; that is simple; and of which installation and fine adjustment are easy.

On the other hand, each of the delay mirrors 1 of Examples 7 to 10 restores (dispersion compensation) the shapes of the first optical pulse and the second optical pulse to those before chirps. In terms of the design target for the delay mirrors 1 of Examples 7 to 10, in the case of the first optical pulse (800 nm wavelength band), GD>0 and GDD<0, and in the case of the second optical pulse (400 nm wavelength band), GD=0 and GDD<0.

That is, each of the delay mirrors 1 of Examples 7 to 10 includes the base 2, and the optical multilayer film 4 formed on the surface R of the base 2. The value of the GD in a first wavelength band (800 nm wavelength band) according to the optical multilayer film 4 is different from the value of the GD in a second wavelength band (400 nm wavelength band) according to the optical multilayer film 4. In addition, the value of the GDD in the first wavelength band according to the optical multilayer film 4 and the value of the GDD in the second wavelength band according to the optical multilayer film 4 are each a negative value. Therefore, each of Examples 7 to 10 provides a delay mirror 1: that causes the shapes of a plurality of optical pulses to be close to the original shapes through negative dispersion and provides a time difference; that can process the plurality of optical pulses in a coaxial manner; that is simple; and of which installation and fine adjustment are easy.

Further, in the delay mirrors 1 of Examples 7 to 10, the value of the GDD in the first wavelength band is a value that realizes dispersion compensation of an 800 nm band optical pulse according to the first wavelength band through a predetermined number of times (ten times) of reflection, and the value of the GDD in the second wavelength band is a value that realizes dispersion compensation of a 400 nm band optical pulse according to the second wavelength band through the predetermined number of times of reflection. Therefore, delay mirrors 1 that each cause the shapes of a plurality of optical pulses to be the original shapes through dispersion compensation and provide a time difference; that can process the plurality of optical pulses in a coaxial manner; that are each simple; and of which installation and fine adjustment are easy, are provided.

Further, in the delay mirror 1 of each of Examples 7 to 10, the fundamental wave FW and the second harmonic SW are those having passed through the nonlinear optical crystal BBO. Therefore, with respect to the titanium sapphire laser light source TS which allows generation of the second harmonic SW (400 nm band) due to passing of the fundamental wave FW (800 nm band) through the nonlinear optical crystal BBO, the delay mirror 1, suitable for the titanium sapphire laser light source TS, that restores the shapes of the fundamental wave FW and the second harmonic SW to those before the passing through the nonlinear optical crystal BBO, and that delays the fundamental wave FW with respect to the second harmonic SW, is provided.

It is noted that, in the delay mirror 1 of the present invention, the GDD may not necessarily be not less than −100 fs² and not greater than 100 fs² in each of the first wavelength band and the second wavelength band, unlike Examples 1-1 to 6.

Similarly, in the delay mirror 1 of the present invention, different from Examples 7 to 10 in which the GDD has a negative value in each of the first wavelength band and the second wavelength band, the GDD may be a positive value in each of the first wavelength band and the second wavelength band, or alternatively, one of the GDD in the first wavelength band and the GDD in the second wavelength band may be a positive value, and the other may be a negative value.

When the GDs are different between the first wavelength band and the second wavelength band, a delay mirror of the optical multilayer film 4 type according to the first wavelength band and the second wavelength band is provided. The GDD according to the first wavelength band and the second wavelength band are selected as appropriate in accordance with the object (e.g., the kind of function to be added to a delay function; keeping of optical pulse shape, dispersion compensation, and the like).

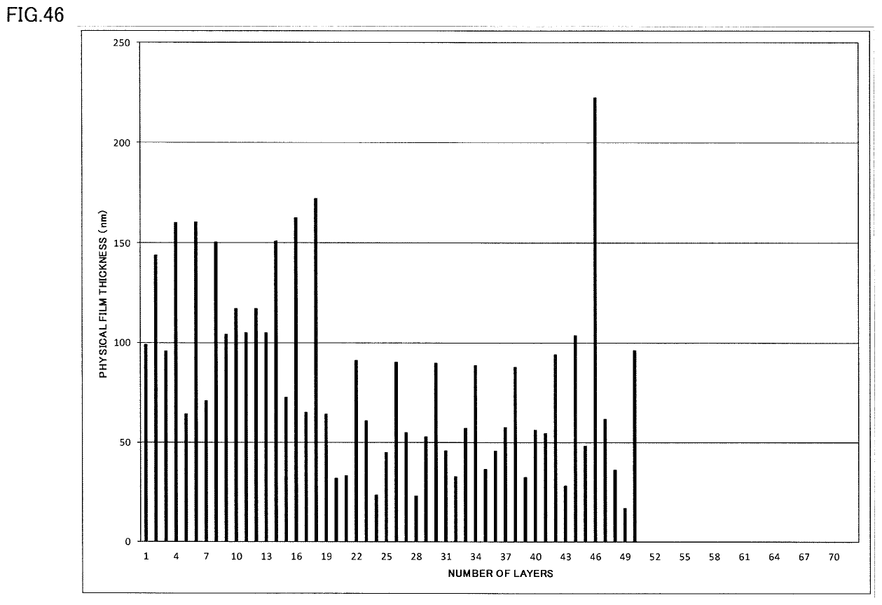

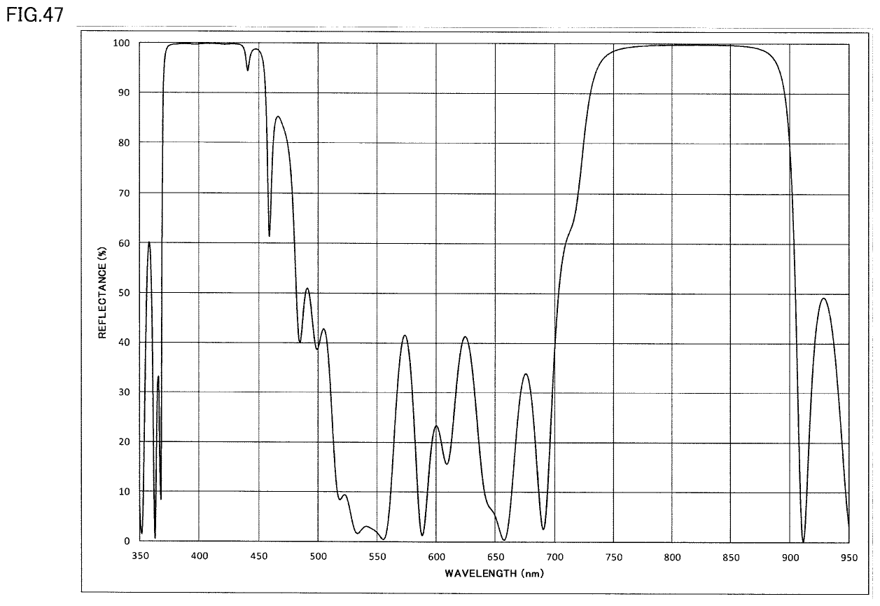

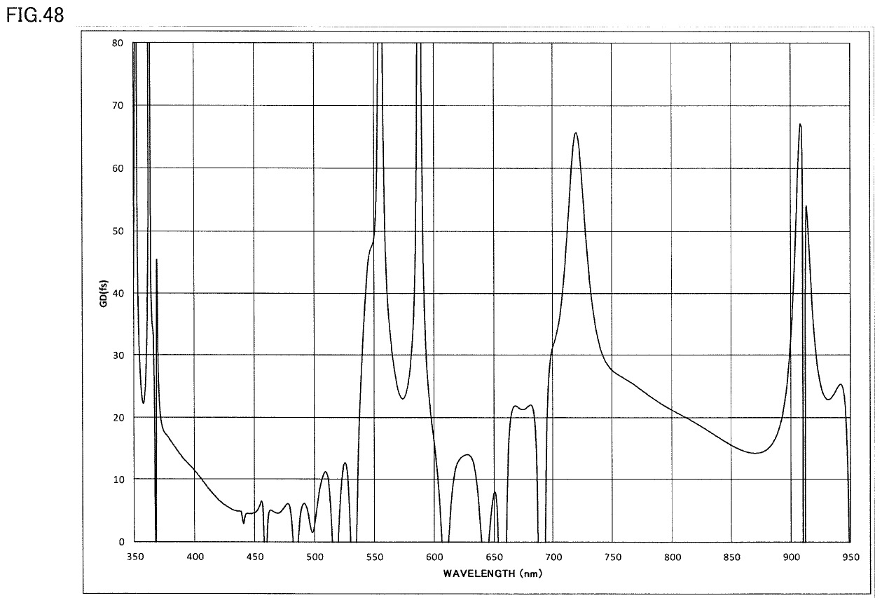

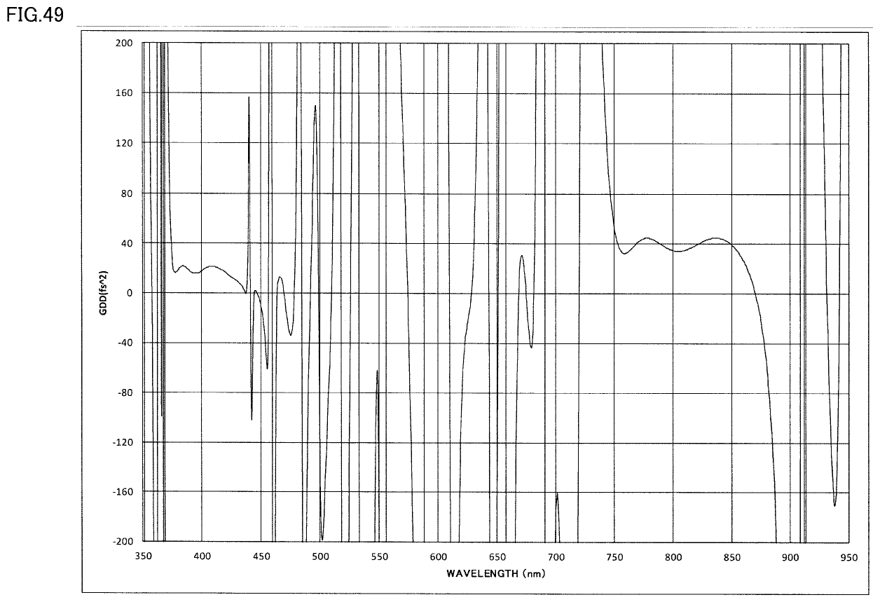

FIG. 46 to FIG. 49 are diagrams similar to FIG. 4 to FIG. 7, according to Example 11. It is noted that FIG. 47 to FIG. 49 are those obtained at an incidence angle of 5°, and the shown wavelength region is not less than 350 nm to 950 nm.

The optical multilayer film 4 of Example 11 is an alternate film in which odd number layers are Ta₂O₅ and even number layers are SiO₂, as in other Examples. The center wavelengths of Example 11 are 400 nm and 800 nm, as in Examples 1-1 to 5 and 7 to 10. The total number of layers of the optical multilayer film 4 of Example 11 is 50.

In Example 11, the group delays GD are different between the 400 nm band and the 800 nm band, and the GDD is a positive value in each of the 400 nm band and the 800 nm band.

Example 11 exhibits high reflection in a wavelength region (400 nm band) of not less than 370 nm and not greater than 430 nm, and in a wavelength region (800 nm band) of not less than 750 nm and not greater than 860 nm.

While the GD of Example 11 is about 12 fs in the 400 nm band, the GD is about 21 fs in the 800 nm band, and the difference of the latter relative to the former is about 9 fs. In Example 11, through a single time of reflection of each optical pulse, the 800 nm band optical pulse is delayed by about 9 fs with respect to the 400 nm band optical pulse.

The GDD of Example 11 is about 20 fs² (positive) in the 400 nm band, and is about 40 fs² (positive) in the 800 nm band.

In Example 11, through reflection of each optical pulse, the 800 nm band optical pulse is delayed by about 9 fs with respect to the 400 nm band optical pulse. In Example 11, with respect to the 800 nm band optical pulse and the 400 nm band optical pulse, a time difference can be provided in a coaxial manner through reflection along the same optical path.

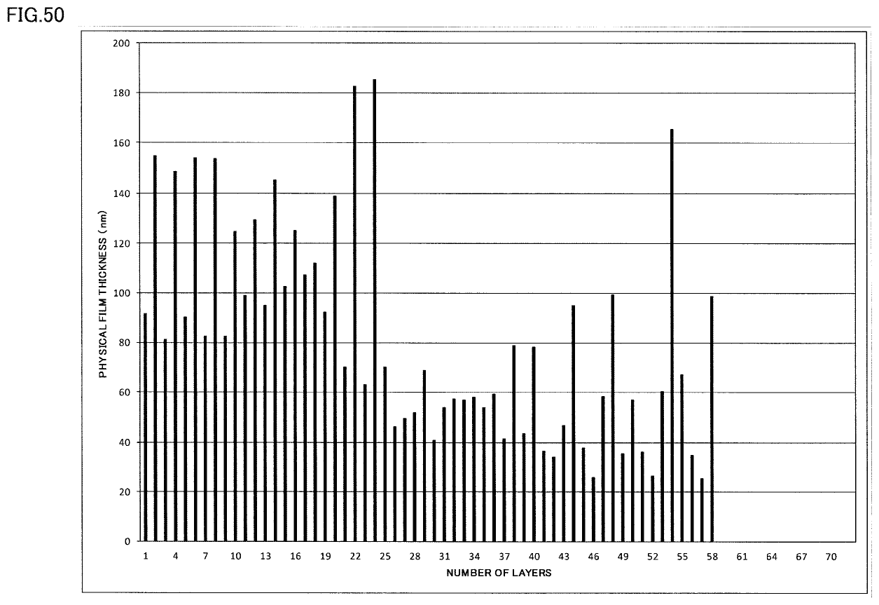

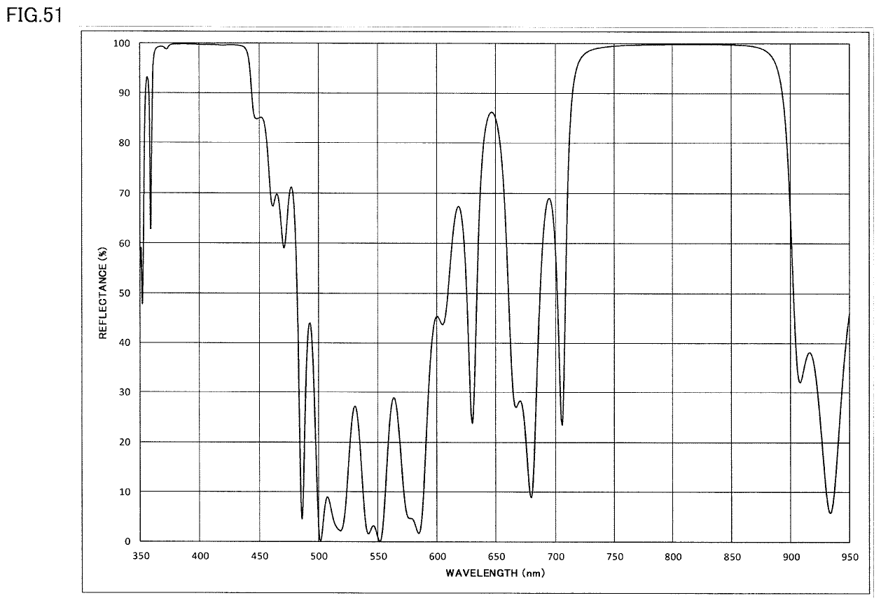

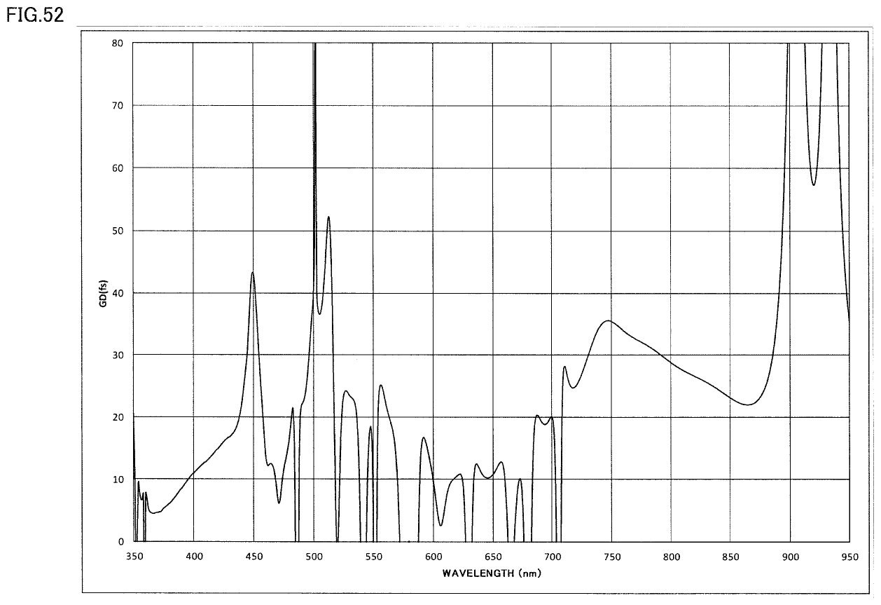

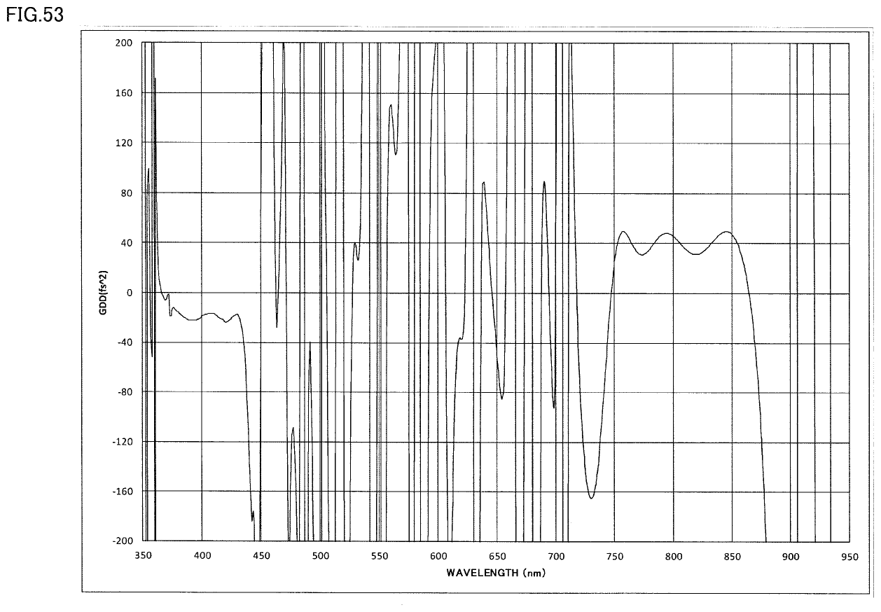

FIG. 50 to FIG. 53 are diagrams similar to FIG. 4 to FIG. 7, according to Example 12. It is noted that FIG. 51 to FIG. 53 are those obtained at an incidence angle of 5°, and the shown wavelength region is not less than 350 nm to 950 nm.

The optical multilayer film 4 of Example 12 is an alternate film in which odd number layers are Ta₂O₅ and even number layers are SiO₂, as in other Examples. The center wavelengths of Example 12 are 400 nm and 800 nm, as in Examples 1-1 to 5 and 7 to 11.

The total number of layers of the optical multilayer film 4 of Example 12 is 58.

In Example 12, the GD are different between a 400 nm band and an 800 nm band. While the GDD is a negative value in the 400 nm band, the GDD is a positive value in the 800 nm band.

Example 12 exhibits high reflection in a wavelength region (400 nm band) of not less than 375 nm and not greater than 440 nm, and in a wavelength region (800 nm band) of not less than 740 nm and not greater than 860 nm.

While the GD of Example 12 is about 11 fs in the 400 nm band, the GD is about 29 fs in the 800 nm band, and the difference of the latter relative to the former is about 18 fs. In Example 12, through a single time of reflection of each optical pulse, the 800 nm band optical pulse is delayed by about 18 fs with respect to the 400 nm band optical pulse.

The GDD of Example 12 is about −20 fs² (negative) in the 400 nm band and about 40 fs² (positive) in the 800 nm band.

In Example 12, through reflection of each optical pulse, the 800 nm band optical pulse is delayed by about 18 fs with respect to the 400 nm band optical pulse. In Example 12, with respect to the 800 nm band optical pulse and the 400 nm band optical pulse, a time difference can be provided in a coaxial manner through reflection along the same optical path.

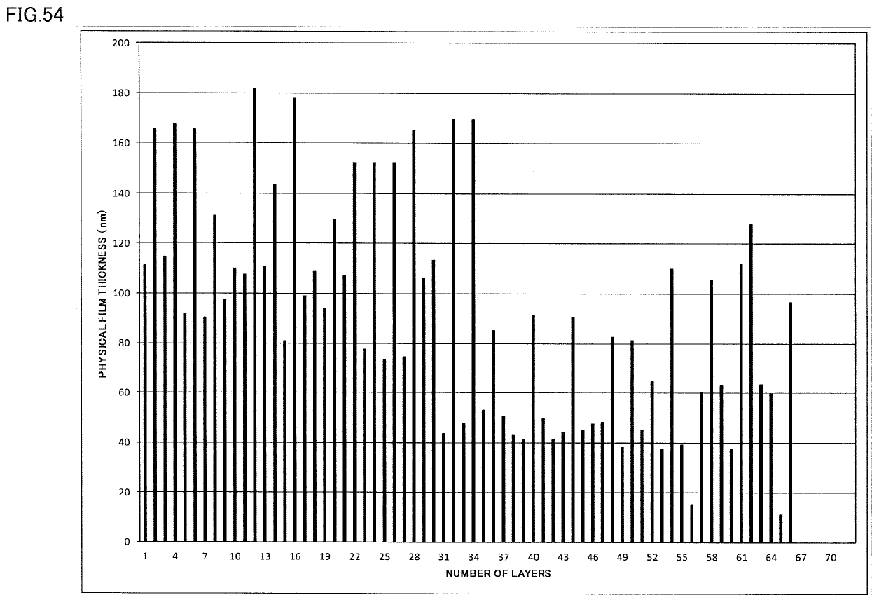

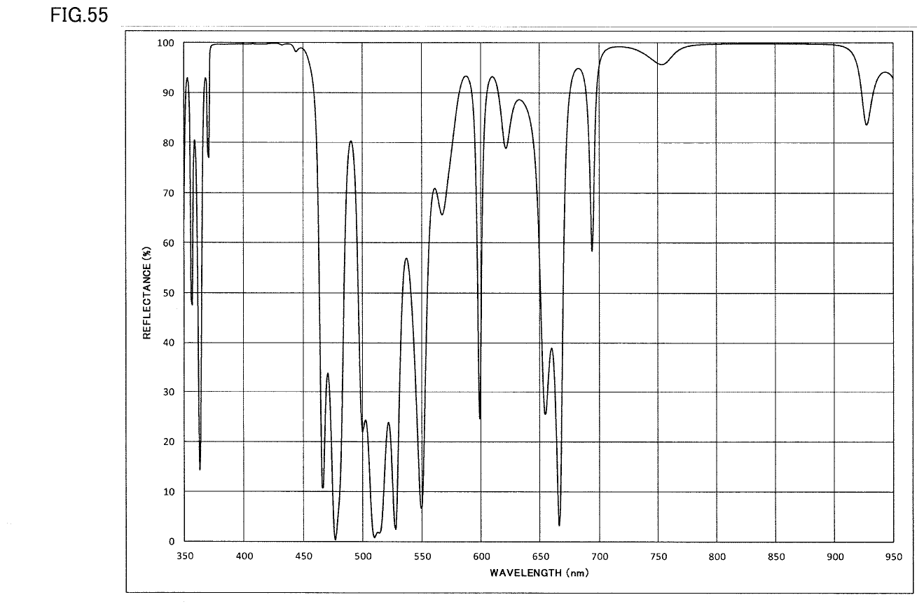

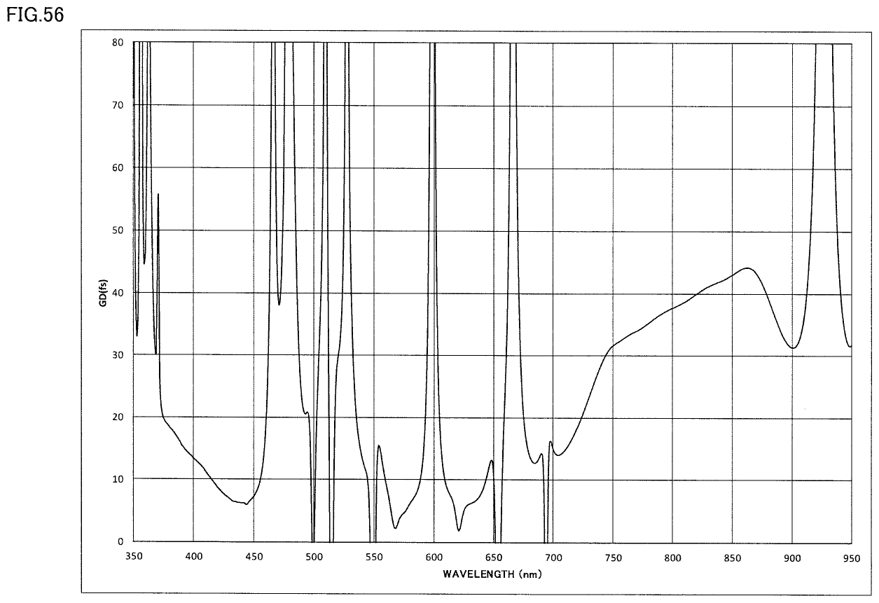

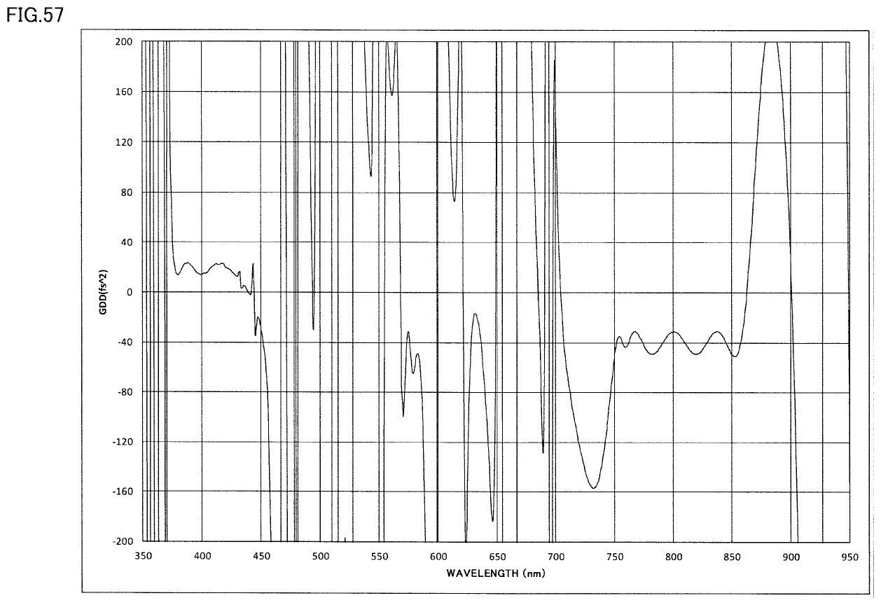

FIG. 54 to FIG. 57 are diagrams similar to FIG. 4 to FIG. 7, according to Example 13. It is noted that FIG. 55 to FIG. 57 are those obtained at an incidence angle of 5°, and the shown wavelength region is not less than 350 nm to 950 nm.

The optical multilayer film 4 of Example 13 is an alternate film in which odd number layers are Ta₂O₅ and even number layers are SiO₂, as in other Examples. The center wavelengths of Example 13 are 400 nm and 800 nm, as in Examples 1-1 to 5 and 7 to 12. The total number of layers of the optical multilayer film 4 of Example 13 is 66.

In Example 13, the GD are different between a 400 nm band and an 800 nm band. While the GDD is a positive value in the 400 nm band, the GDD is a negative value in the 800 nm band.

Example 13 exhibits high reflection in a wavelength region (400 nm band) of not less than 370 nm and not greater than 440 nm, and in a wavelength region (800 nm band) of not less than 770 nm and not greater than 900 nm.

While the GD of Example 13 is about 14 fs in the 400 nm band, the GD is about 38 fs in the 800 nm band, and the difference of the latter relative to the former is about 24 fs. In Example 13, through a single time of reflection of each optical pulse, the 800 nm band optical pulse is delayed by about 24 fs with respect to the 400 nm band optical pulse.

The GDD of Example 13 is about 20 fs² (positive) in the 400 nm band, and is about −40 fs² (negative) in the 800 nm band.

In Example 13, through reflection of each optical pulse, the 800 nm band optical pulse is delayed by about 24 fs with respect to the 400 nm band optical pulse. In Example 13, with respect to the 800 nm band optical pulse and the 400 nm band optical pulse, a time difference can be provided in a coaxial manner through reflection along the same optical path.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A delay mirror comprising:
a base; and
an optical multilayer film formed on a surface of the base, wherein
a value of a group delay in a first wavelength band according to the optical multilayer film is different from a value of the group delay in a second wavelength band according to the optical multilayer film.

2. The delay mirror according to claim 1, wherein
a value of a group delay dispersion in the first wavelength band according to the optical multilayer film and a value of the group delay dispersion in the second wavelength band according to the optical multilayer film are each not less than −100 fs² and not greater than 100 fs².

3. The delay mirror according to claim 1, wherein
a value of a group delay dispersion in the first wavelength band according to the optical multilayer film and a value of the group delay dispersion in the second wavelength band according to the optical multilayer film are each a negative value.

4. The delay mirror according to claim 3, wherein
the value of the group delay dispersion in the first wavelength band is a value that realizes dispersion compensation of a first optical pulse according to the first wavelength band through a predetermined number of times of reflection, and
the value of the group delay dispersion in the second wavelength band is a value that realizes dispersion compensation of a second optical pulse according to the second wavelength band through a predetermined number of times of reflection.

5. The delay mirror according to claim 4, wherein
the first optical pulse and the second optical pulse are those having passed through a nonlinear optical crystal.

6. The delay mirror according to claim 1, wherein
a value of a group delay dispersion in the first wavelength band according to the optical multilayer film and a value of a group delay dispersion in the second wavelength band according to the optical multilayer film are each a positive value.

7. The delay mirror according to claim 1, wherein
out of a value of a group delay dispersion in the first wavelength band according to the optical multilayer film and a value of a group delay dispersion in the second wavelength band according to the optical multilayer film, one is a positive value and another is a negative value.

8. The delay mirror according to claim 1, wherein
out of the first wavelength band and the second wavelength band, one is a 400 nm band and another is an 800 nm band.

9. The delay mirror according to claim 1, wherein
out of the first wavelength band and the second wavelength band, one is a 515 nm band and another is a 1030 nm band.

10. A delay mirror system comprising:
the delay mirror according to claim 1; and
a delay mirror movement mechanism configured to move the delay mirror with respect to another mirror such that a number of times of reflection at the delay mirror is changed.

11. The delay mirror system according to claim 10, comprising
a pair of the delay mirrors.
